(19) United States
(12) Patent Application Publication
(10) Pub. No.: US 2018/0356711 A1
(43) Pub. Date: Dec. 13, 2018

(54) CONTROL APPARATUS, CONTROL UNIT, AND IMAGING UNIT

(71) Applicant: Sony Corporation, Tokyo (JP)

(72) Inventors: Katsuyoshi Otsuka, Ibaraki (JP); Kouji Shimizu, Tokyo (JP); Yuuji Sasaki, Tokyo (JP); Keita Okuda, Kanagawa (JP); Mokuyoh Nakano, Tokyo (JP); Shunsuke Izumi, Tokyo (JP); Takayuki Houshiyama, Tokyo (JP); Yoshihiro Aoyanagi, Kanagawa (JP); Tomotsugu Minamikawa, Tokyo (JP); Takumi Suzuki, Kanagawa (JP); Takahiro Tsuge, Tokyo (JP); Keiichi Iwasaki, Tokyo (JP)

(21) Appl. No.: 15/779,643

(22) PCT Filed: Nov. 14, 2016
(86) PCT No.: PCT/JP2016/083721

§ 371 Date: May 29, 2018

(30) Foreign Application Priority Data
Dec. 28, 2015 (JP) 2015-257188

(51) Int. Cl. G03B 17/56

(52) U.S. Cl. CPC G03B 17/568; G03B 17/566

(57) ABSTRACT

To improve the convenience of handling.

It includes a communication unit capable of wirelessly communicating with an imaging apparatus; a display control unit that displays information regarding the imaging apparatus on the basis of communication with the imaging apparatus; and an attachable/detachable portion that is engageable with a locking portion of an accessory and attachable/detachable to/from the locking portion of the accessory. Accordingly, since it can be wirelessly connected to the imaging apparatus and control can be performed on the imaging apparatus in a state where the control apparatus is locked to the accessory, it is possible to improve the convenience of handling.

### TECHNICAL FIELD

The present technology relates to the technical field of a control apparatus mountable on an accessary and an imaging unit including the same.

### CITATION LIST

### Patent Literature

Patent Literature 1: Japanese Patent Application Laid-open No. 2012-74945

Patent Literature 2: Japanese Patent Application Laid-open No. 2015-73216

### BACKGROUND ART

Various imaging apparatuses such as a video camera and a still camera are attached to accessories and used (see, for example, Patent Literature 1 and Patent Literature 2).

By using such an accessory, it is possible to perform, by attaching an imaging apparatus to the accessory, imaging under various imaging states such as a high angle and a low angle. By using the accessory, the imaging state is diversified, and it is possible to take an image of an object in a desired direction or at a desired angle and enhance the visibility of the object at the time of imaging, which can improve the usability.

The imaging apparatus disclosed in Patent Literature 1 is attached to a frame-shaped accessory and used. Since the accessory is shaped like a frame, it is easy to hold the accessary, and it is possible to secure a stable imaging state.

The imaging apparatus disclosed in Patent Literature 2 is slidable with respect to an accessory, and it is possible to change the angle of the imaging apparatus with respect to the accessory by sliding the imaging apparatus with respect to the accessory. By changing the angle of the imaging apparatus with respect to the accessory, it is possible to perform imaging with the imaging apparatus being in a desired orientation, and perform imaging under various imaging states.

Meanwhile, it is convenient if control of executing or stopping an imaging operation can be performed on the imaging apparatus by a control apparatus such as a remote control apparatus in a state where the imaging apparatus is attached to another part or another portion other than the accessory in addition to the state where the imaging apparatus is attached to the accessory as described above. Examples of the state where the imaging apparatus is attached to another part or another portion other than the accessory include a state where the imaging apparatus is attached to a vehicle such as a bicycle and an automobile and a state where the imaging apparatus is attached to a part of a human body such as an arm and a head or an ornament such as a belt and a hat attached to the body.

### DISCLOSURE OF INVENTION

### Technical Problem

As described above, imaging performed by an imaging apparatus is further diversified according to scenes and circumstances such as imaging while moving, imaging in a state of being mounted on a vehicle such as a bicycle, and imaging in a state of being mounted on the body.

Further, in recent years, there are an increasing number of examples where transmission/reception of imaging data by wireless communication or the like with an imaging apparatus, imaging control for an imaging apparatus, or the like is performed by a control apparatus such as a remote control apparatus.

Therefore, in an accessory to which an imaging apparatus is attached, it is desired to improve the functionality, corresponding to the above-mentioned diversification of the imaging states and the imaging situation using a control apparatus or the like, and perform handling suitable for use, use situation, and the like on the control apparatus.

In view of the above, it is an object of the control apparatus, the control unit, and the imaging unit of the present technology to improve the convenience of handling.

### Solution to Problem

Firstly, an accessory according to the present technology includes: a communication unit capable of wirelessly communicating with an imaging apparatus; a display control unit that displays information regarding the imaging apparatus on the basis of communication with the imaging apparatus; and an attachable/detachable portion that is engageable with a locking portion of an accessory and attachable/detachable to/from the locking portion of the accessory.

Accordingly, in a state of being locked to the accessory, it can be wirelessly connected to the imaging apparatus and control can be performed on the imaging apparatus.

Secondary, in the above-mentioned accessory, it is desired that an engaging projecting portion and an engaging recessed portion are formed, one of the engaging projecting portion and the engaging recessed portion is formed as the attachable/detachable portion, and the other of the engaging projecting portion and the engaging recessed portion is engaged with a recessed portion or a projecting portion formed in the accessory.

Accordingly, the control apparatus can be mounted on the accessory only in a state where the engaging projecting portion and the engaging recessed portion are in a positional relationship corresponding to the recessed portion and the projecting portion, respectively.

Thirdly, in the above-mentioned accessory, it is desired that a casing is provided, the display control unit being placed in the casing, a main body portion and a to-be-mounted projecting portion are provided in the casing, the display control unit being placed in the main body portion, the to-be-mounted projecting portion projecting from the main body portion, the to-be-mounted projecting portion including the attachable/detachable portion, and the to-be-mounted projecting portion is inserted in a mounting recessed portion in a state of being attached to the accessory, the mounting recessed portion being formed in the accessory.

Accordingly, the control apparatus is mounted on the accessory in a state where the to-be-mounted projecting portion is inserted in the mounting recessed portion.

Fourthly, in the above-mentioned accessory, it is desired that a casing is provided, the display control unit being placed in the casing, a main body portion and a to-be-mounted projecting portion are provided in the casing, the display control unit being placed in the main body portion, the to-be-mounted projecting portion projecting from the main body portion, the engaging projecting portion and the engaging recessed portion are formed in the to-be-mounted projecting portion, and the to-be-mounted projecting portion is inserted in a mounting recessed portion in a state of being attached to the accessory, the mounting recessed portion being formed in the accessory.

Accordingly, the engaging projecting portion and the engaging recessed portion are closed by the accessory.

Fifthly, in the above-mentioned accessory, it is desired that a to-be-guided inclined surface slidable on an opening edge of the mounting recessed portion is formed in the to-be-mounted projecting portion.

Accordingly, the to-be-guided inclined surface is slidable on the opening edge of the mounting recessed portion when the control apparatus is mounted on the accessory.

Sixthly, in the above-mentioned accessory, it is desired that a plurality of contact portions that are point-contacted with corresponding parts of the accessory in a state of being attached to the accessory are provided.

Accordingly, in a state where the control apparatus is mounted on the accessory, the control apparatus is supported while the plurality of contact portions are point-contacted.

Seventhly, in the above-mentioned accessory, it is desired that a casing is provided, the display control unit being placed in the casing, a plurality of operation buttons including an imaging button for causing the imaging apparatus to execute an imaging operation are placed in the casing, and the display control unit and the imaging button are placed on the same surface of the casing.

Accordingly, the operation state by the operation on the imaging button can be checked by the display control unit placed at the position close to the imaging button.

Eighthly, in the above-mentioned accessory, it is desired that the imaging button and another operation button are placed on different surfaces of the casing.

Accordingly, an unintended operation on another button is hardly performed at the time of operating the imaging button having the strongest relationship with the display control unit.

Ninthly, in the above-mentioned accessory, it is desired that the operation buttons are placed on opposite surfaces of the casing, the opposite surfaces are formed to have the same size and the same shape, and a position on one of the opposite surfaces of the operation button placed on the one of the opposite surfaces is different from a position on the other of the opposite surfaces of the operation button placed on the other of the opposite surfaces.

Accordingly, the operation buttons placed on the one surface and the operation buttons placed on the other surface are located at asymmetric positions.

Tenthly, in the above-mentioned accessory, it is desired that at least one of surfaces of the casing is formed to have a recessed surface, and at least one of the operation buttons is placed on the recessed surface.

Accordingly, even when it is placed while the recessed surface faces a placing surface such as a desk and a table, the operation buttons placed on the recessed surface are hardly pressed by the placing surface.

Eleventhly, in the above-mentioned accessory, it is desired that a connection terminal to be connected to a terminal portion of the accessory is provided, the connection terminal is slidable with respect to the accessory, and the connection terminal is slidable on the connection terminal in a sliding state with respect to the accessory.

Accordingly, when the control apparatus is slid and mounted on the accessory, the dust adhered to the connection terminal and the terminal portion is removed by the sliding.

Twelfthly, in the above-mentioned accessory, it is desired that a camera attachment portion and an apparatus mounting portion are provided in the accessory, the imaging apparatus being attachable/detachable to/from the camera attachment portion, the apparatus mounting portion including a locking portion to be engaged with the attachable/detachable portion, and the control apparatus is locked to the apparatus mounting portion by the locking portion.

Accordingly, control on the imaging apparatus can be performed by the control apparatus in a state where the imaging apparatus is attached to the camera attachment portion.

Thirteenthly, in the above-mentioned accessory, it is desired that a mounting portion including the apparatus mounting portion is provided in the accessory, and the mounting portion is attachable/detachable to/from a part including the camera attachment portion.

Accordingly, the control apparatus can be mounted on the apparatus mounting portion in a state where the mounting portion including the apparatus mounting portion is detached from the part including the camera attachment portion.

Fourteenthly, in the above-mentioned accessory, it is desired that a grip portion to be held by a finger is provided in the accessory.

Accordingly, it is possible to use the control apparatus while holding the grip portion by a finger in a state where the imaging apparatus is attached to the camera attachment portion.

Fifteenthly, in the above-mentioned accessory, it is desired that the apparatus mounting portion is rotatable with respect to the camera attachment portion, and an orientation with respect to the imaging apparatus is changed in accordance with rotation of the apparatus mounting portion.

Accordingly, the orientation of the control apparatus with respect to the imaging apparatus is changed by rotating the apparatus mounting portion with respect to the camera attachment portion.

Sixteenthly, in the above-mentioned accessory, it is desired that a weep hole is formed in the accessory.

Accordingly, rainwater is discharged from the weep hole in the rainfall situation.

Seventeenthly, in the above-mentioned accessory, it is desired that the accessory is attachable to a part of a human body, and a knob for causing a lock lever including the locking portion to operate is provided on a side of a surface in contact with the body in a state of being attached to the part of the body.

Accordingly, an operation on the knob cannot be performed in a state where the accessory is mounted on the body.

Fifteenthly, in the above-mentioned accessory, it is desired that an elastically deformable elastic deformation portion is provided in the accessory, and the locking portion is provided in the elastic deformation portion.

Accordingly, the locking portion is engaged with the control apparatus along with the deformation of the elastic deformation portion.

Ninteenthly, a control unit according to the present technology includes: an accessory including a locking portion; and a control apparatus including a communication unit capable of wirelessly communicating with an imaging apparatus, a display control unit that displays information regarding the imaging apparatus on the basis of communication with the imaging apparatus, and an attachable/detachable portion that is engageable with a locking portion of an accessory and attachable/detachable to/from the locking portion of the accessory.

Accordingly, in the control apparatus, in a state of being locked to the accessory, it can be wirelessly connected to the imaging apparatus and control can be performed on the imaging apparatus.

Twenteenthly, an imaging unit according to the present technology includes: an imaging apparatus having an imaging function; an accessory including a locking portion; and a control apparatus including a communication unit capable of wirelessly communicating with an imaging apparatus, a display control unit that displays information regarding the imaging apparatus on the basis of communication with the imaging apparatus, and an attachable/detachable portion that is engageable with a locking portion of an accessory and attachable/detachable to/from the locking portion of the accessory.

Accordingly, in the control apparatus, in a state of being locked to the accessory, it can be wirelessly connected to the imaging apparatus and control can be performed on the imaging apparatus.

### Advantageous Effects of Invention

According to the present technology, since it can be wirelessly connected to the imaging apparatus and control can be performed on the imaging apparatus in a state where the control apparatus is locked to the accessory, it is possible to improve the convenience of handling.

It should be noted that the effects described herein are merely examples and are not limited, and additional effects may be provided.

### BRIEF DESCRIPTION OF DRAWINGS

FIG. 1 shows an embodiment of a control apparatus, a control unit, and an imaging unit of the present technology together with FIG. 2 to FIG. 44, and is a perspective view of an imaging apparatus.

FIG. 2 is a perspective view of a control apparatus.

FIG. 3 is a perspective view showing the control apparatus as seen from a direction different from that in FIG. 2.

FIG. 4 is a left side view of the control apparatus.

FIG. 5 is a right side view of the control apparatus.

FIG. 6 is a front view of the control apparatus.

FIG. 7 is a rear view of the control apparatus.

FIG. 8 is a bottom view of the control apparatus.

FIG. 9 is a perspective view of a first accessory.

FIG. 10 is an exploded perspective view of the first accessory.

FIG. 11 is a side view of the first accessory.

FIG. 12 is a plan view of the first accessory.

FIG. 13 is a bottom view of the first accessory.

FIG. 14 is a cross-sectional view taken along the line XIV-XIV in FIG. 11.

FIG. 15 is a perspective view showing an imaging unit including the first accessory, in which the imaging apparatus, the control apparatus, and the accessory are separated.

FIG. 16 is a perspective view of the imaging unit including the first accessory.

FIG. 17 is a side view of the imaging unit including the first accessory.

FIG. 18 is a side view showing a state where a finger is inserted in a grip portion of the first accessory and the accessory is held.

FIG. 19 is a side view showing a state where an apparatus mounting portion of the first accessory is rotated.

FIG. 20 is a perspective view showing the control unit including a second accessary, in which the control apparatus and the accessory are separated.

FIG. 21 is a perspective view showing the control unit including the second accessory as seen from a direction different from that in FIG. 20, in which the control apparatus and the accessory are separated.

FIG. 22 is a perspective view showing the control unit including the second accessory.

FIG. 23 is a perspective view showing the control unit including the third accessory, in which the control apparatus and the accessory are separated.

FIG. 24 is a perspective view showing the control unit including a third unit as seen from a direction different from that in FIG. 23, in which the control apparatus and the accessory are separated.

FIG. 25 is a bottom view of the third accessory.

FIG. 26 is a side view showing a state where a belt is mounted on the third accessory.

FIG. 27 is a perspective view of a locking mechanism.

FIG. 28 is a partial cross-sectional plan view showing a state where the control apparatus is locked.

FIG. 29 is a perspective view showing the control unit including the third accessory.

FIG. 30 is a partial cross-sectional plan view showing a state where a lock lever is rotated and the locking of the control apparatus is released.

FIG. 31 is a perspective view showing the control unit including a fourth accessory, in which the control apparatus and the accessory are separated.

FIG. 32 is a perspective view showing the control unit including the fourth accessory as seen from a direction different from that in FIG. 31, in which the control apparatus and the accessory are separated.

FIG. 33 is a perspective view showing a state where an attachable/detachable portion is detached from a main body in the control unit including the fourth accessory.

FIG. 34 is a perspective view showing a state where the imaging unit including the fourth accessory is used as a tripod.

FIG. 35 is a perspective vie showing the control unit including the fourth accessory.

FIG. 36 is a perspective view showing the control unit including a fifth accessory, in which the control apparatus and the accessory are separated.

FIG. 37 is a perspective view showing the control unit including the fifth accessory as seen from a direction different from that in FIG. 36, in which the control apparatus and the accessory are separated.

FIG. 38 is a bottom surface showing the fifth accessory.

FIG. 39 is an enlarged cross-sectional view showing a part of a first belt of the fifth accessory.

FIG. 40 is an enlarged cross-sectional view showing a part of a second belt of the fifth accessory.

FIG. 41 is a perspective view showing the control unit including the fifth accessory.

FIG. 42 is an enlarged cross-sectional view showing a state where a second belt is inserted in a belt insertion hole of the first belt in the fifth accessory.

FIG. 43 is an enlarged cross-sectional view showing a state where the second belt is inserted in a snap ring in the fifth accessory, subsequent to FIG. 42.

FIG. 44 is an enlarged cross-sectional view showing a state where a fastening projecting portion of the first belt is inserted in a fastening hole of the second belt in the fifth accessory, subsequent to FIG. 42.

### MODE(S) FOR CARRYING OUT THE INVENTION

Hereinafter, an embodiment for carrying out the present technology will be described with reference to the accompanying drawings.

A control apparatus according to an embodiment described below includes a display control unit and an imaging button. In the following description, longitudinal, vertical, and lateral directions are shown on the assumption that the direction in which the display control unit faces is upward, the direction in which the display control unit and the imaging button are arranged is a longitudinal direction, and the display control unit side in the positional relationship between the display control unit and the imaging button is a front side.

Note that the longitudinal, vertical, and lateral directions described below are for convenience of the description, and implementation of the present technology is not limited to these directions.

<Configuration, Etc. of Imaging Apparatus>

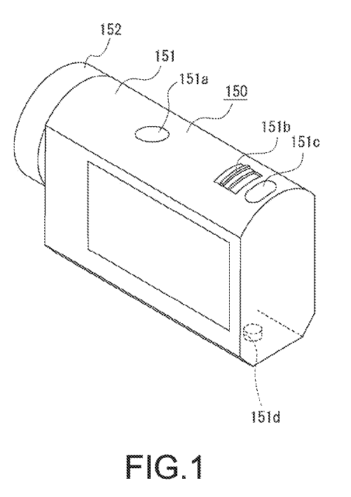

A schematic configuration of an imaging apparatus 150 will be described first (see FIG. 1). The imaging apparatus 150 is attached to an accessory to be described later and used. Alternatively, imaging apparatus 150 is not attached to the accessory, and is attached to another part or another portion other than the accessory and used.

The imaging apparatus 150 is, for example, a video camera, and the length thereof in the longitudinal direction is longer than those in the vertical and lateral directions. The imaging apparatus 150 includes a camera main body 151, and an imaging unit 152 that projects forward from an upper part of the front surface of the camera main body 151. The camera main body 151 is formed to have a vertical cross-sectional shape of, for example, a vertically long oval shape.

On the upper surface of the camera main body 151, a power source button 151a, a switching knob 151b, and a lighting unit 151c are arranged in order from front to back. The switching knob 151b is, for example, an operation unit that switches availability of wireless communication with a control apparatus to be described later. The lighting unit 151c is turned on when a pressing operation is performed on the power source button 151a and the power is turned on, and used for recognizing that the imaging apparatus 150 is in a driving state.

At the rear end portion of the camera main body 151, a fitting hole 151d opened downward is formed. The fitting hole 151d is, for example, a positioning hole into which a positioning pin or a mounting screw is to be inserted provided in a tripod when being mounted on the tripod.

<Configuration, Etc. of Control Apparatus>

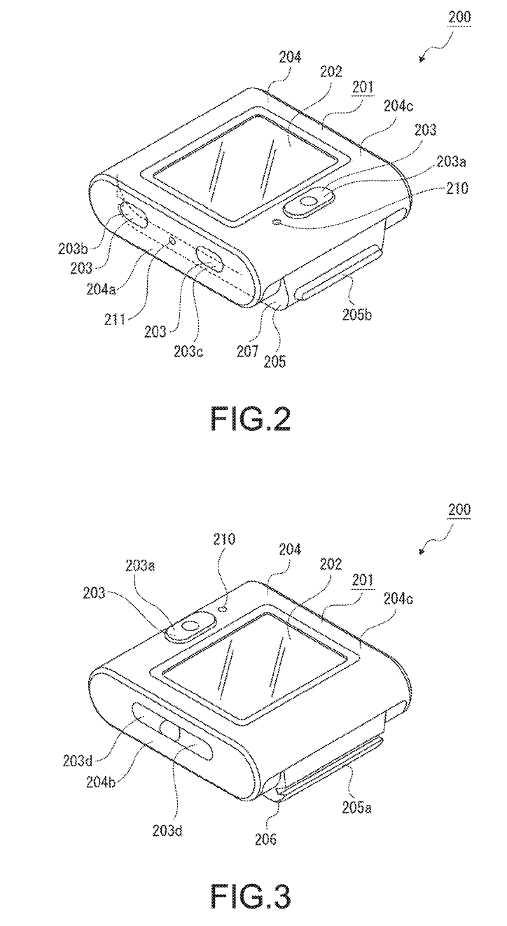

Next, a configuration of a control apparatus 200 will be described (see FIG. 2 to FIG. 8). The control apparatus 200 is mounted on an accessory and used. However, the control apparatus 200 can be used also in a state where it is not mounted on the accessory, e.g., it is held by a hand.

The control apparatus 200 is, for example, a remote control apparatus, is capable of wirelessly connecting to the imaging apparatus 150, and has a function of performing various types of control on the imaging apparatus 150. By using the control apparatus 200, for example, it is possible to display an image or video taken by the imaging apparatus 150, or set or change various imaging modes or imaging states for the imaging apparatus 150.

Note that the control apparatus 200 may be capable of performing, for example, control on a portable information terminal, a computer, or the like, or transmission/reception of data with these apparatuses, in addition to control on the imaging apparatus 150.

The transmission/reception of signals in the control apparatus 200 may be performed any of communication means such as wired communication and wireless communication including a wireless LAN (Local Area Network) or near field communication, and a communication function including transmission/reception of these signals is performed by a communication unit provided therein.

The control apparatus 200 includes a casing 201, a display control unit 202, and operation buttons 203, 203, . . . .

The casing 201 includes a main body portion 204 formed to have a flat substantially rectangular shape, and a to-be-mounted projecting portion 205 that protrudes downward from a part of the main body portion 204 excluding right and left end portions thereof.

The front end portion of the main body portion 204 is formed to have a semi-cylindrical shape that projects forward, and the rear end portion of the main body portion 204 is formed to have a semi-cylindrical shape that projects rearward. The right and left end portions of the main body portion 204 are each formed to have a shallow recessed shape opened laterally. The left side surface is formed as a first recessed surface 204a, and the right side surface is formed as a second recessed surface 204b. The first recessed surface 204a and the second recessed surface 204b have the same size and shape.

The surfaces of the to-be-mounted projecting portion 205 at the front and rear end portions are each formed to have a circular arc shape that projects outwardly, and the surface at the front end portion is formed as a sliding contact surface 206.

At the front end portion of the to-be-mounted projecting portion 205, an engaging recessed portion 205a that is opened forward and extends laterally is formed. The engaging recessed portion 205a is formed as an attachable/detachable portion (to-be-locked portion), and formed continuously with the upper edge of the sliding contact surface 206 (see FIG. 5 and FIG. 7). At the rear end portion of the to-be-mounted projecting portion 205, an engaging projecting portion 205b that projects rearward and extends laterally is provided. At the central portion of the to-be-mounted projecting portion 205 in the longitudinal direction, a projecting portion for terminal 205c that projects leftward is provided.

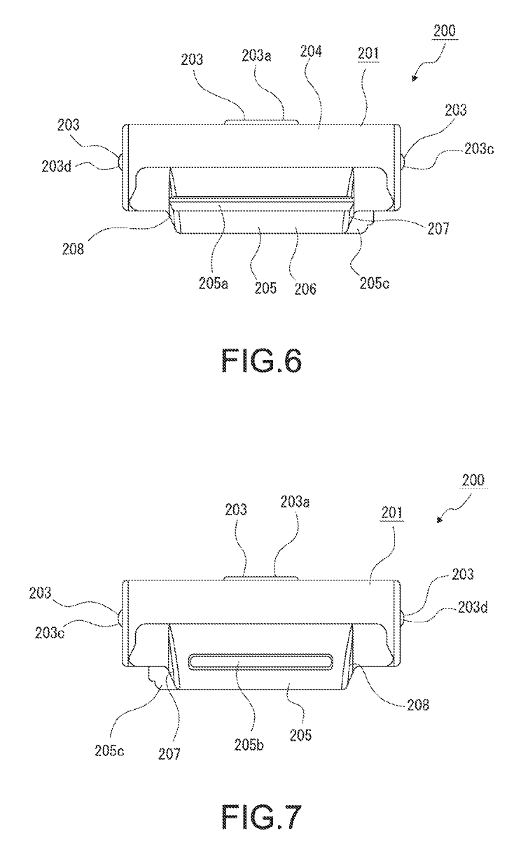

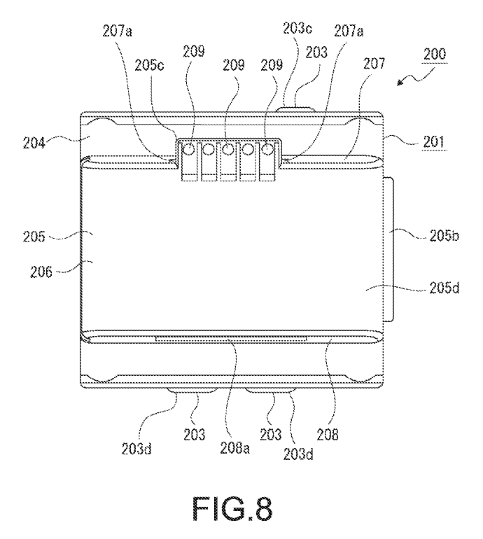

The left and right side surfaces of the to-be-mounted projecting portion 205 are respectively formed as to-be-guided inclined surfaces 207 and 208 (see FIG. 6 and FIG. 8). The to-be-guided inclined surfaces 207 and 208 are gently inclined so as to be displaced in a mutually approaching direction as they go downward.

On the to-be-guided inclined surface 207 on the left side, first contact portions 207a, 207a are formed on the front and rear sides of the projecting portion for terminal 205c. The first contact portions 207a, 207a are each formed to have a shallow recessed shape.

On the to-be-guided inclined surface 208 on the right side, a second contact portion 208a that extends longitudinally is formed. The second contact portion 208a is formed to have a shallow recessed shape.

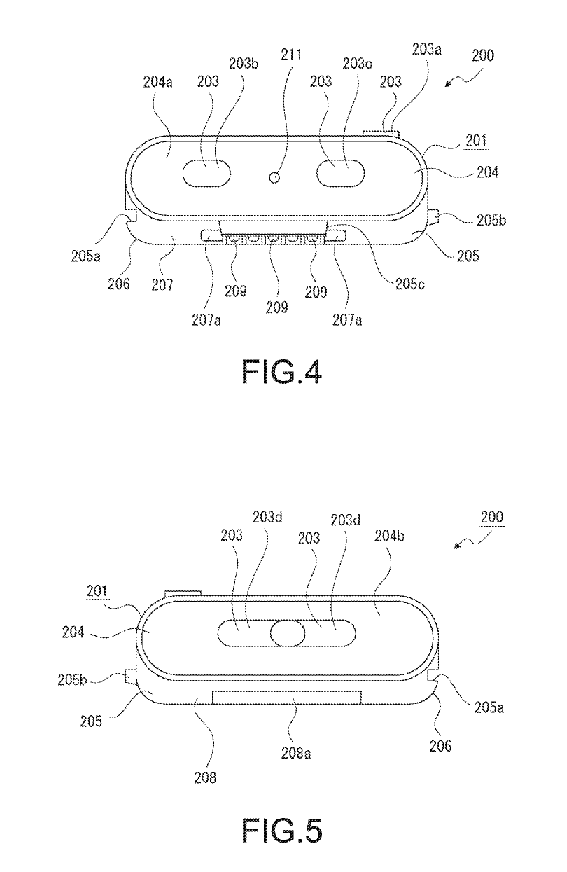

In the to-be-mounted projecting portion 205, connection terminals 209, 209, . . . are provided to be arranged longitudinally on the projecting portion for terminal 205c (see FIG. 4 and FIG. 8). The connection terminals 209, 209, . . . are located above a lower surface 205d of the to-be-mounted projecting portion 205.

The display control unit 202 is placed on an upper surface 204c of the main body portion 204 (see FIG. 2 and FIG. 3). On the display control unit 202, various types of information such as a driving state of the imaging apparatus 150 and a set mode, as well as an image or video taken by the imaging apparatus 150 can be displayed.

The operation buttons 203, 203, . . . are placed on, for example, the upper surface 204c, and the first recessed surface 204a and the second recessed surface 204b, which are left and right side surfaces, of the main body portion 204 (see FIG. 2 to FIG. 5). As the operation buttons 203, 203, . . . , for example, an imaging button 203a, a power source button 203b, a menu display button 203c, and menu selection buttons 203d, 203d are provided.

The imaging button 203a is placed on, for example, the rear side of the display control unit 202 in the upper surface 204c. By operating the imaging button 203a, for example, it is possible to take a still image. Note that it may be configured to be capable of, for example, taking a moving image in addition to a still image by operating the imaging button 203a. Further, the imaging button 203a may be provided as a button common to the power source button 203b. The power source button 203b and the menu display button 203c are placed on, for example, the first recessed surface 204a so as to be separated longitudinally. The menu selection buttons 203d, 203d are placed on, for example, the second recessed surface 204b so as to be separated longitudinally.

The distance between the power source button 203b and the menu display button 203c is larger than the distance between the menu selection buttons 203d, 203d so that the positions of the power source button 203b and the menu display button 203c on the first recessed surface 204a are different from the positions of the menu selection buttons 203d, 203d on the second recessed surface 204b.

As described above, the plurality of operation buttons 203, 203 are provided in the control apparatus 200, and the display control unit 202 and the imaging button 203a are placed on the same surface of the casing 201.

Therefore, since the display control unit 202 capable of displaying an image or video and the imaging button 203a for executing an operation of taking an image or video are placed on the same surface, the operation state by the operation on the imaging button 203a can be checked by the display control unit 202 placed at a position close to the imaging button 203a, which makes it possible to improve usability of the control apparatus 200.

Further, the imaging button 203a and other operation buttons, i.e., the power source button 203b, the menu display button 203c, and the menu selection buttons 203d, 203d are placed on different surfaces of the casing 201.

Therefore, since the imaging button 203a that has the strongest relationship with the display control unit 202 and a high usage frequency and the other buttons are placed on different surfaces, the other buttons are not operated unintentionally at the time of operating the imaging button 203a having a high usage frequency, thereby making it possible to suppress erroneous operations.

Further, the positions of the power source button 203b and the menu display button 203c on the first recessed surface 204a are different from the positions of the menu selection buttons 203d, 203d on the second recessed surface 204b.

Therefore, since the power source button 203b and the menu display button 203c placed on the first recessed surface 204a, and the menu selection buttons 203d, 203d placed on the second recessed surface 204b are placed at asymmetrical positions, the operation buttons 203, 203 placed on the first recessed surface 204a and the operation buttons 203, 203 placed on the second recessed surface 204b are hardly operate at the same time in a state where the first recessed surface 204a and the second recessed surface 204b are held by respective fingers, thereby making it possible to suppress erroneous operations.

Further, since the first recessed surface 204a and the second recessed surface 204b are formed in the casing 201, and the operation buttons 203, 203, . . . are placed on the first recessed surface 204a and the second recessed surface 204b, the projecting amount from the casing 201 of the operation buttons 203, 203, . . . formed on the first recessed surface 204a and the second recessed surface 204b is reduced.

Therefore, in the case where the control apparatus 200 is placed while the first recessed surface 204a or the second recessed surface 204b faces a placing surface (upper surface) such as a desk and a table, the operation buttons 203, 203, . . . placed on the first recessed surface 204a and the second recessed surface 204b are hardly pressed by the placing surface, and it is possible to suppress erroneous operations in a state where the control apparatus 200 is placed on the placing surface.

In particular, since the power source button 203b is formed to have a size that does not project leftward from the left end of the casing 201 (see FIG. 8), the power source button 203b is not pressed by the placing surface in the case where the control apparatus 200 is placed while the first recessed surface 204a faces the placing surface, which makes it possible to prevent the power source from being unintentionally turned on and turned off.

On the upper surface 204c of the main body portion 204, a first light emitting unit 210 is placed in the vicinity of the imaging button 203a (see FIG. 2 and FIG. 3). The first light emitting unit 210 emits light when the imaging button 203a is operated, and it is possible to recognize, by the light emission of the first light emitting unit 210, that the imaging apparatus 150 is in an imaging state.

On the first recessed surface 204a of the main body portion 204, a light emitting unit 211 is placed between the power source button 203b and the menu display button 203c (see FIG. 2 and FIG. 4). The light emitting unit 211 emits light when the power source button 203b is operated, and it is possible to recognize, by the light emission of the light emitting unit 211, that the control apparatus 200 is in a driving state.

<Configuration, Etc. of Accessory>

Hereinafter, a configuration, etc. of an accessory will be described. As the accessory on which the control apparatus 200 is to be mounted, for example, a first accessory 1A, a second accessory 1B, a third accessory 1C, a fourth accessory 1D, or a fifth accessory 1E is used.

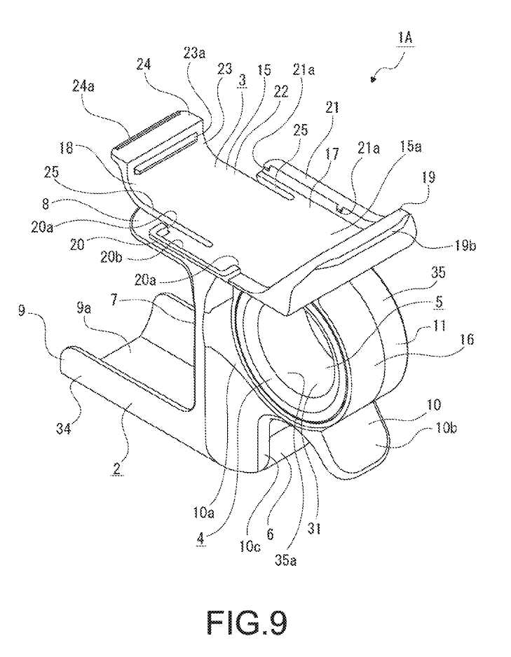

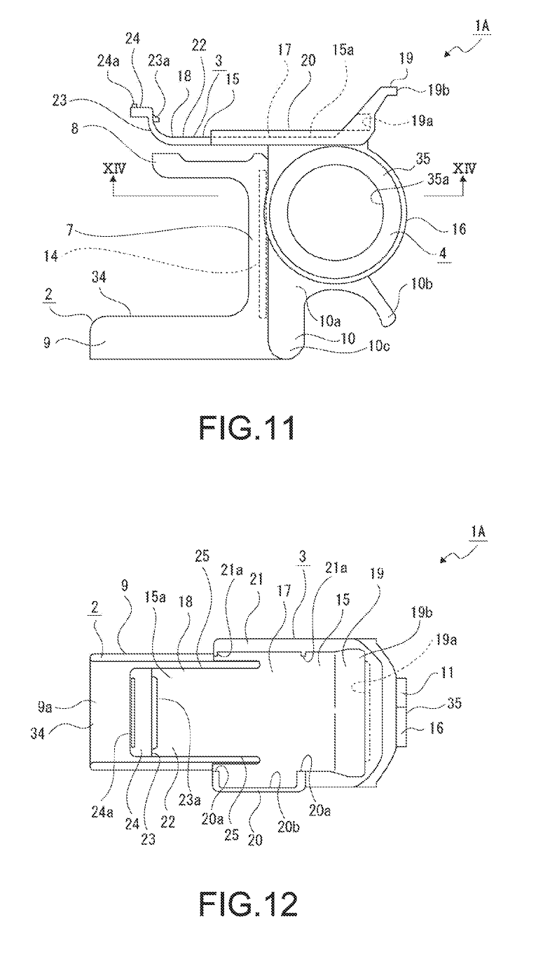

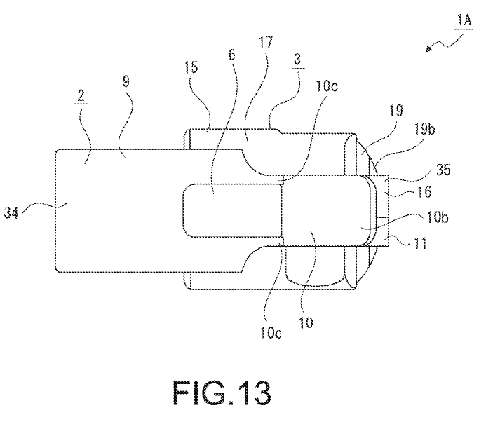

A configuration, etc. of the first accessory 1A will be described first (see FIG. 9 to FIG. 16).

The first accessory 1A includes a base member 2, a movable member 3, a rotation member 4, a fixed member 5, and a locking member 6 (see FIG. 9 to FIG. 14).

The base member 2 includes a substantially flat plate-like coupling surface portion 7 oriented in the longitudinal direction, a first holding portion 8 that projects forward from the upper end portion of the coupling surface portion 7, a second holding portion 9 that projects forward from the lower end portion of the coupling surface portion 7, a projecting portion 10 that projects substantially rearward from the coupling surface portion 7, and a supporting portion 11 that is continuously provided on the upper side of the projecting portion 10.

The coupling surface portion 7 is formed to have a vertically long shape, and the upper edge portion thereof is formed to have a semicircular arc shape that projects upward.

The first holding portion 8 is formed to have a gentle circular arc shape that projects upward with the central portion in the lateral direction thereof located uppermost. In the first holding portion 8, a facing hole 8a is formed.

The second holding portion 9 is located to face the first holding portion 8 and larger in size in the longitudinal direction than the first holding portion 8, and the front end thereof is located forward relative to the front end of the first holding portion 8.

The upper surface of the second holding portion 9 is formed as a gentle circular arc surface 9a that projects downward with the central portion in the lateral direction thereof located lowermost.

The projecting portion 10 includes a support portion 10a that projects obliquely rearward and downward from a portion close to the upper end of the coupling surface portion 7, a support projecting portion 10b that projects obliquely rearward and downward from the rear end of the support portion 10a, and leg portions 10c, 10c that project downward from the right and left end portions of the support portion 10a. The front ends of the leg portions 10c, 10c are continuous to the right and left end portions of the coupling surface portion 7.

In the base member 2, a supporting hole 2a is formed at a portion extending from the projecting portion 10 to the coupling surface portion 7. The supporting hole 2a penetrates in the longitudinal direction, and is opened downward.

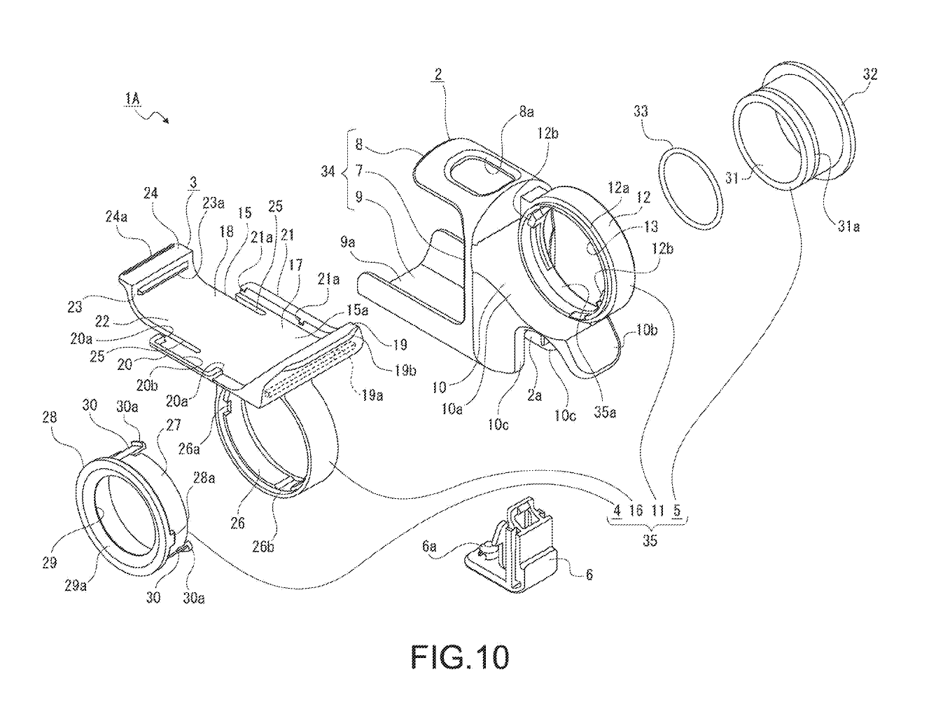

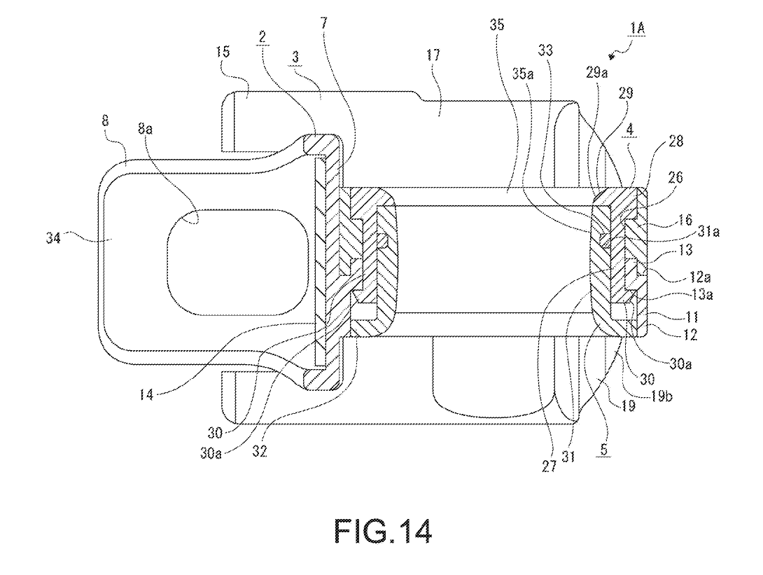

The supporting portion 11 is formed to have a substantially annular shape penetrating in the lateral direction, and continuously provided at a portion extending from the substantially upper half portion of the coupling surface portion 7 to the support portion 10a of the projecting portion 10. The supporting portion 11 includes an outer annular surface portion 12 and an inner annular surface portion 13, and the inner annular surface portion 13 projects leftward from the left end portion of the outer annular surface portion 12 (see FIG. 10 and FIG. 14).

The inner annular surface portion 13 is located on the inner peripheral side of the outer annular surface portion 12, and the left side surface of the outer annular surface portion 12 and the right side surface of the inner annular surface portion 13 are formed as stepped surfaces. These stepped surfaces are an outer stepped surface 12a and an inner stepped surface 13a.

In the outer annular surface portion 12, stopper projecting portions 12b, 12b that project inward are provided apart from each other in the circumferential direction. The stopper projecting portions 12b, 12b are provided at positions continuous to the outer stepped surface 12a and the inner annular surface portion 13.

To the front surface of the coupling surface portion 7 in the base member 2, a cushion 14 is adhered (see FIG. 14).

The movable member 3 is formed by integrally forming an apparatus mounting portion 15 and a ring portion 16 (see FIG. 9 to FIG. 14).

The apparatus mounting portion 15 includes a flat plate-like receiving surface portion 17 that is directed in the substantially vertical direction, an elastic deformation portion 18 continuous to the front end of the receiving surface portion 17, and a mounting projecting portion 19 continuous to the rear end of the receiving surface portion 17.

The left and right end portions of the receiving surface portion 17 are provided as receiving projecting portions 20 and 21 that project upward relative to other parts. The receiving projecting portion 20 on the left side is formed to have a shape in which the front and rear end portions thereof project rightward from other parts, and the right end portions are provided as supporting projections 20a, 20a. The space on the right side of the receiving projecting portion 20 is formed as a placement recessed portion 20b opened rightward and upward. On the left side portion of the receiving projecting portion 21 on the right side, supporting projections 21a, 21a are provided apart from each other in the longitudinal direction.

In the apparatus mounting portion 15, a recessed portion opened upward is formed between the receiving projecting portions 20 and 21. This recessed potion is formed as a mounting recessed portion 15a.

The elastic deformation portion 18 is continuous to a part excluding the right and left end portions of the receiving surface portion 17, and includes a flat plate-like connecting portion 22 directed in the vertical direction, a holding projecting portion 23 bent so as to project upward from the front end portion of the connecting portion 22, and a horizontally long to-be-operated portion 24 that projects forward from the upper end portion of the holding projecting portion 23.

Between the connecting portion 22 and the front end portions of the receiving projecting portions 20 and 21, slits 25, 25 opened forward are formed. Therefore, the elastic deformation portion 18 is elastically deformable in the direction in which the front end portion thereof is displaced in the vertical direction with respect to the receiving surface portion 17.

On the rear surface of the holding projecting portion 23, a locking portion 23a that projects rearward and extends in the lateral direction is provided.

In the front end portion of the upper surface of the to-be-operated portion 24, an anti-slip projecting portion 24a that projects upward and extends in the lateral direction is provided. The to-be-operated portion 24 is a portion to be pressed downward to elastically deform the elastic deformation portion 18.

On the front surface of the mounting projecting portion 19, an engaging groove 19a that extends in the lateral direction is formed. The upper end portion of the mounting projecting portion 19 is provided as a finger hanging operation portion 19b. A part of the finger hanging operation portion 19b projects rearward. The finger hanging operation portion 19b has a function of being operated by placement of a finger, and the movable member 3 is rotated with respect to the base member 2 by operating the finger hanging operation portion 19b.

The ring portion 16 is formed to have a substantially annular shape penetrating in the lateral direction, and the upper end portion thereof is continuous to the lower end portion of the receiving surface portion 17. The ring portion 16 is provided as a protruding portion 26 in which a portion excluding the right and left end portions protrudes inward (see FIG. 10 and FIG. 14).

In the protruding portion 26, positioning recessed portions 26a, 26a opened leftward and inward are formed apart from each other in the circumferential direction. In the protruding portion 26, recessed portion for insertion 26b, 26b opened in the lateral direction and inward are formed apart from each other in the circumferential direction.

The ring portion 16 is coupled to the supporting portion 11 from the left side, and thus, the movable member 3 is rotatably supported by the base member 2. In a state where the movable member 3 is supported by the base member 2, the right end surface of the ring portion 16 is located so as to face the outer stepped surface 12a formed in the outer annular surface portion 12 of the supporting portion 11, and the right end surface of the protruding portion 26 is located so as to face the left end surface of the inner annular surface portion 13 in the supporting portion 11.

The rotation member 4 includes an annular portion 27 formed to have a substantially annular shape penetrating in the lateral direction, an outer flange portion 28 that expands outward from the left end portion of the annular portion 27, an inner flange portion 29 that expands inward from the left end portion of the annular portion 27, and sliding engaging portions 30, 30 that project rightward from the annular portion 27.

In the outer flange portion 28, positioning projecting portions 28a, 28a that project rightward are provided apart from each other in the circumferential direction.

The sliding engaging portions 30, 30 are provided apart from each other in the circumferential direction, and include engaging claws 30a, 30a that project outward at the tip portions thereof.

The rotation member 4 is coupled to the ring portion 16 of the movable member 3 from the left side. The positioning projecting portions 28a, 28a are inserted and positioned in the positioning recessed portions 26a, 26a formed in the protruding portion 26, the sliding engaging portions 30, 30 are inserted through the recessed portion for insertion 26b, 26b formed in the protruding portion 26 and project rightward from the ring portion 16, and thus, the coupling of the rotation member 4 to the ring portion 16 is performed. At this time, the sliding engaging portions 30, 30 that project from the ring portion 16 to the right side are elastically deformed by the engaging claws 30a, 30a being in sliding contact with the inner annular surface portion 13 the base member 2, and elastically restored when they pass over the inner annular surface portion 13, and thus, the engaging claws 30a, 30a are engaged with the inner stepped surface 13a. In the rotation member 4, the right side surface of the outer flange portion 28 is located so as to face the left side surface of the protruding portion 26, and the outer flange portion 28 of the rotation member 4 and the inner annular surface portion 13 of the base member 2 are located on the left and right sides of the protruding portion 26.

As described above, the outer flange portion 28 of the rotation member 4 and the inner annular surface portion 13 of the base member 2 are located on the left and right sides of the protruding portion 26 in the ring portion 16, the engaging claws 30a, 30a are engaged with the inner stepped surface 13a, and thus, the ring portion 16 and the rotation member 4 are prevented from falling off from the supporting portion 11. Since the positioning projecting portions 28a, 28a are inserted in the positioning recessed portion 26a, 26a, the rotation member 4 is rotated around the ring portion 16 as a fulcrum integrally with the movable member 3 with respect to the base member 2.

The movable member 3 and the rotation member 4 are rotatable with respect to the base member 2 within the range that the engaging claws 30a, 30a are in contact with the stopper projecting portions 12b, 12b provided in the supporting portion 11.

The fixed member 5 is formed of a rubber material or a resin material to have a substantially annular shape penetrating in the lateral direction, and includes a finger placement portion 31 and a flange portion 32 that expands outward from the right end portion of the finger placement portion 31 (see FIG. 10).

On the outer surface side of the finger placement portion 31, a mounting groove 31a that extends in the circumferential direction is formed.

An O-ring 33 is inserted in and mounted on the mounting groove 31a of the finger placement portion 31. The O-ring 33 is formed of, for example, a rubber material.

The fixed member 5 is inserted in the supporting portion 11 of the base member 2 from the right side, and fixed to the supporting portion 11 by press fitting, bonding, or the like. In the state where the fixed member 5 is fixed to the supporting portion 11, the flange portion 32 is located on the inner peripheral side of the right end portion of the outer annular surface portion 12, the left half portion of the finger placement portion 31 is located on the inner peripheral side of the annular portion 27 in the rotation member 4, and the left end surface of the finger placement portion 31 is located so as to face the right side surface of the inner flange portion 29 in the rotation member 4. At this time, the O-ring 33 is pressed against the inner peripheral surface of the annular portion 27 from the inside, and friction occurs between the annular portion 27 and the O-ring 33.

The locking member 6 is inserted in the supporting hole 2a formed in the base member 2 from below, and supported by the base member 2 so as to be movable in the vertical direction. In the front end portion of the locking member 6, a fitting projecting portion 6a that projects upward is provided.

In the first accessory 1A configured as described above, as shown in FIG. 9 and FIG. 10, the coupling surface portion 7, the first holding portion 8, and the second holding portion 9 of the base member 2 function as a camera attachment portion 34 to/from which the imaging apparatus 150 is attachable/detachable, and the apparatus mounting portion 15 of the movable member 3 is provided as a part to which the control apparatus 200 is mounted. Further, the supporting portion 11 of the base member 2, the ring portion 16 of the movable member 3, the rotation member 4, and the fixed member 5 function as a grip portion 35 to be held by a finger. The grip portion 35 is formed to have an annular shape, and the internal space of the grip portion 35 is formed as an insertion hole 35a in which a finger is to be inserted.

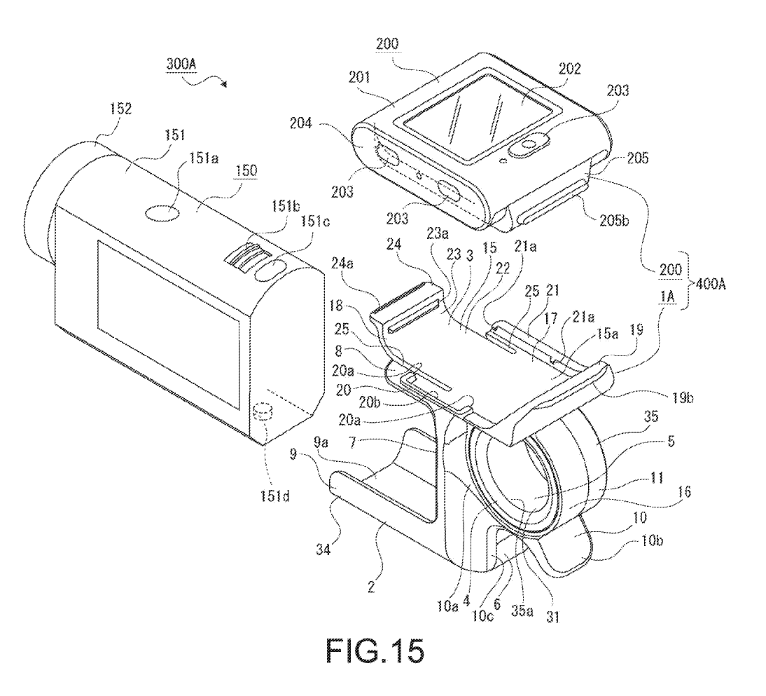

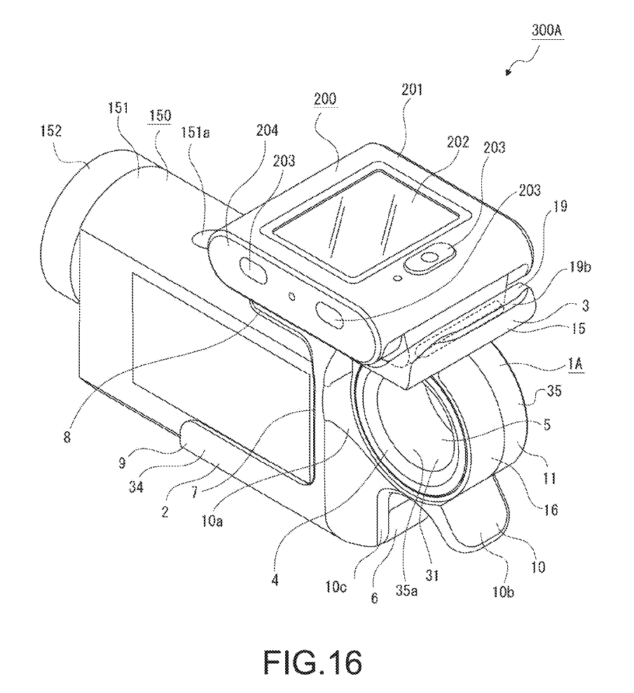

Further, in the first accessory 1A, by attaching the imaging apparatus 150 to the camera attachment portion 34, and mounting the control apparatus 200 on the apparatus mounting portion 15, the first accessory 1A, the imaging apparatus 150, and the control apparatus 200 constitute an imaging unit 300A (see FIG. 15 and FIG. 16).

Further, in the first accessory 1A, by mounting the control apparatus 200 on the apparatus mounting portion 15 while the imaging apparatus 150 is not attached to the camera attachment portion 34, the first accessory 1A and the control apparatus 200 constitute a control unit 400A.

Hereinafter, attachment of the imaging apparatus 150 to the first accessory 1A will be described.

The rear end portion of the camera main body 151 is inserted between the first holding portion 8 and the second holding portion 9 in the first accessory 1A from the front side, the imaging apparatus 150 is supported by the first holding portion 8 and the second holding portion 9 from above and below, and thus, the imaging apparatus 150 is attached to the camera attachment portion 34 (see FIG. 16). In the state where the imaging apparatus 150 is attached to the camera attachment portion 34, the rear surface of the camera main body 151 is pressed against the cushion 14 adhered to the front surface of the coupling surface portion 7, which suppresses scratching of the camera main body 151 and rattling of the imaging apparatus 150 with respect to the camera attachment portion 34.

In the state where the imaging apparatus 150 is attached to the camera attachment portion 34, the power source button 151a of the imaging apparatus 150 is located in front of the first holding portion 8, and the switching knob 151b and the lighting unit 151c are located at the facing hole 8a formed in the first holding portion 8. Therefore, in the state where the imaging apparatus 150 is attached to the camera attachment portion 34, a user is capable of operating the power source button 151a, and operating the switching knob 151b and viewing the state of the lighting unit 151c via the facing hole 8a.

When the locking member 6 that has been moved downward is operated and moved upward in the state where the imaging apparatus 150 is attached to the camera attachment portion 34, the fitting projecting portion 6a of the locking member 6 is fit into the fitting hole 151d formed in the camera main body 151, and the imaging apparatus 150 is locked in the camera attachment portion 34. On the contrary, when the locking member 6 is operated and moved downward in the state where the imaging apparatus 150 is attached to the camera attachment portion 34, the fitting projecting portion 6a of the locking member 6 is pulled out the fitting hole 151d formed in the camera main body 151, and the imaging apparatus 150 can be detached from the first accessory 1A by pulling the imaging apparatus 150 forward from the camera attachment portion 34.

Next, mounting of the control apparatus 200 on the first accessory 1A will be described.

The control apparatus 200 is inserted in a state of being inclined forward and upward between the holding projecting portion 23 and the mounting projecting portion 19 in the first accessory 1A from above, and the engaging projecting portion 205b is inserted in the engaging groove 19a. When the front end portion is pressed downward in the state where the engaging projecting portion 205b is inserted in the engaging groove 19a, the sliding contact surface 206 of the to-be-mounted projecting portion 205 is in sliding contact with the locking portion 23a of the holding projecting portion 23, and the elastic deformation portion 18 is elastically deformed in the direction in which the holding projecting portion 23 and the to-be-operated portion 24 are displaced downward.

In this case, since the to-be-guided inclined surfaces 207 and 208 are formed in the to-be-mounted projecting portion 205 of the control apparatus 200, when the front end portion of the control apparatus 200 is pressed downward, the to-be-guided inclined surfaces 207 and 208 are respectively slidable on inner edges of the receiving projecting portions 20 and 21, and the to-be-mounted projecting portion 205 is inserted in the mounting recessed portion 15a of the apparatus mounting portion 15.

Therefore, it is possible to easily and reliably insert the to-be-mounted projecting portion 205 in the mounting recessed portion 15a.

When the engaging recessed portion 205a corresponds to the locking portion 23a in the state where the elastic deformation portion 18 is elastically deformed as described above, the elastic deformation portion 18 is elastically restored, the locking portion 23a is inserted in and engaged with the engaging recessed portion 205a, and thus, the control apparatus 200 is mounted on the apparatus mounting portion 15.

In the state where the control apparatus 200 is mounted on the first accessory 1A, the to-be-mounted projecting portion 205 is inserted in the mounting recessed portion 15a formed in the first accessory 1A.

Therefore, since the control apparatus 200 is mounted on the first accessory 1A in the state where the to-be-mounted projecting portion 205 is inserted in the mounting recessed portion 15a, a stable mounted state with respect to the first accessory 1A can be secured. Also, since the main body portion 204 is not inserted in the mounting recessed portion 15a, a favorable visibility for the display control unit 202 can be secured.

In particular, since the to-be-mounted projecting portion 205 is inserted in the mounting recessed portion 15a, the control apparatus 200 hardily slides with respect to the first accessory 1A, and it is possible to prevent the control apparatus 200 from falling off from the first accessory 1A.

Further, since the to-be-mounted projecting portion 205 is inserted in the mounting recessed portion 15a, it is possible to reduce the overall size of the first accessory 1A.

Further, the engaging projecting portion 205b and the engaging recessed portion 205a are formed in the to-be-mounted projecting portion 205, and the to-be-mounted projecting portion 205 is inserted in the mounting recessed portion 15a in the state where the control apparatus 200 is mounted on the first accessory 1A.

Therefore, since the to-be-mounted projecting portion 205 is mounted on the first accessory 1A in the state where the to-be-mounted projecting portion 205 is inserted in the mounting recessed portion 15a, the engaging projecting portion 205b and the engaging recessed portion 205a are closed by the first accessory 1A, a hand does not accidentally come into contact with the engaging projecting portion 205b and the engaging recessed portion 205a in the state where the control apparatus 200 is mounted on the first accessory 1A, and thus, it is possible to prevent the control apparatus 200 from unintentionally falling off from the first accessory 1A.

Further, the engaging projecting portion 205b is engaged with the engaging groove 19a that is a recessed portion, the engaging recessed portion 205a is engaged with the locking portion 23a that is a projecting portion of the first accessory 1A, and thus, the control apparatus 200 is mounted on the first accessory 1A.

Therefore, since the control apparatus 200 can be mounted on the first accessory 1A only in the state where the engaging projecting portion 205b and the engaging recessed portion 205a are in a positional relationship corresponding to the engaging groove 19a and the locking portion 23a, respectively, the control apparatus 200 is mounted always in a predetermined orientation on the first accessory 1A, and it is possible to prevent the control apparatus 200 from being mounted in a wrong orientation on the first accessory 1A.

In the state where the control apparatus 200 is mounted on the apparatus mounting portion 15, the supporting projections 20a, 20a of the receiving projecting portion 20 are brought into contact with the first contact portions 207a, 207a, and the supporting projections 21a, 21a of the receiving projecting portion 21 are brought into contact with the second contact portion 208a.

Therefore, since the casing 201 is supported by the supporting projections 20a, 20a, 21a, and 21a in a state of being point-contacted at four points, rattling of the control apparatus 200 with respect to the apparatus mounting portion 15 is suppressed, and the control apparatus 200 is mounted in a stable state on the apparatus mounting portion 15.

Further, at this time, the projecting portion for terminal 205c of the to-be-mounted projecting portion 205 is inserted in the placement recessed portion 20b formed by the receiving projecting portion 20. Therefore, since any part of the apparatus mounting portion 15 does not come into contact with the connection terminals 209, 209, . . . , it is possible to prevent the connection terminals 209, 209, . . . from being scratched or damaged.

When a pressing operation is performed on the to-be-operated portion 24 in the lower direction in the state where the control apparatus 200 is mounted on the apparatus mounting portion 15, the elastic deformation portion 18 is elastically deformed in the direction in which the holding projecting portion 23 and the to-be-operated portion 24 are displaced downward, and the engagement of the locking portion 23a with the engaging recessed portion 205a is released. Therefore, by pulling out the engaging projecting portion 205b from the engaging groove 19a and lifting the control apparatus 200 upward from the apparatus mounting portion 15, it is possible to detach the control apparatus 200 from the first accessory 1A.

As described above, the elastic deformation portion 18 that is to be elastically deformed when the control apparatus 200 is mounted is provided in the apparatus mounting portion 15 of the first accessory 1A, and the locking portion 23a that is to be engaged with the control apparatus 200 is provided in the elastic deformation portion 18.

Therefore, since the locking portion 23a is engaged with the control apparatus 200 by the deformation of the elastic deformation portion 18, it is possible to easily mount the control apparatus 200 on the apparatus mounting portion 15 with a simple structure.

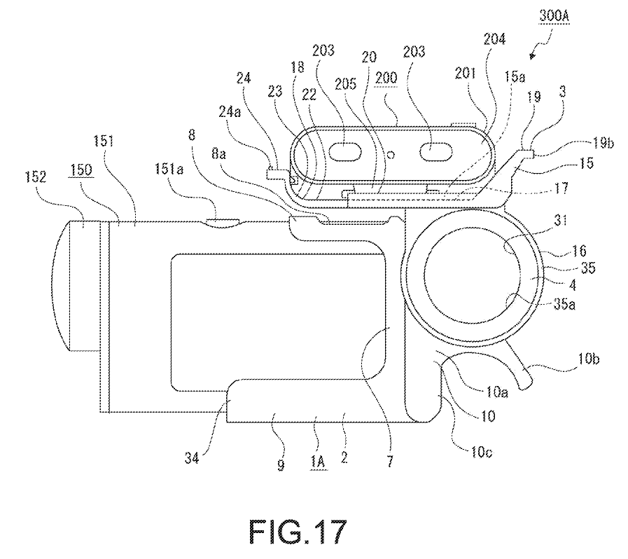

Next, a usage mode of the first accessory 1A will be described (see FIG. 17 to FIG. 19).

Before using the first accessory 1A, for example, the receiving surface portion 17 of the apparatus mounting portion 15 is in a horizontal state by the weight of the control apparatus 200, the apparatus mounting portion 15 is located at a first rotation position, and the control apparatus 200 is located closest to the imaging apparatus 150 (see FIG. 17). At this time, the engaging claw 30a of one sliding engaging portion 30 in the rotation member 4 is brought into contact with one stopper projecting portion 12b of the supporting portion 11 in the base member 2, which regulates rotation of the apparatus mounting portion 15 in the direction of being inclined to the front side.

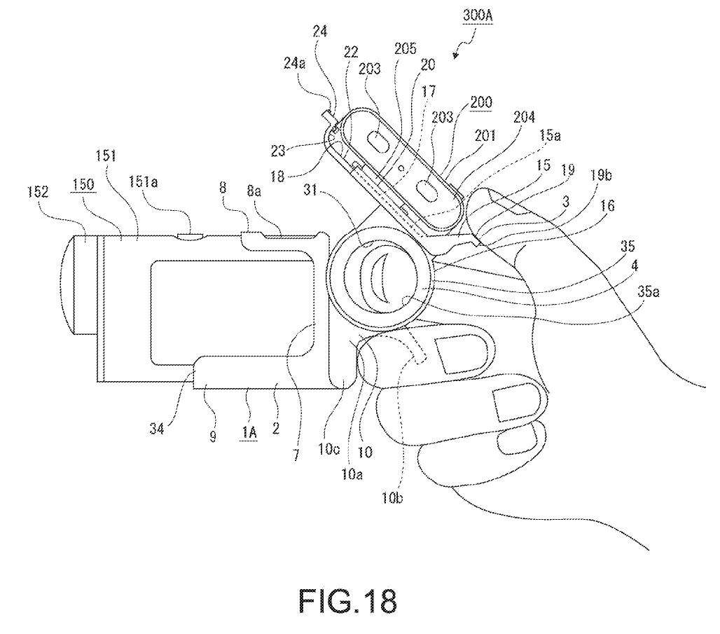

A user inserts, for example, the index finger in the grip portion 35, places, for example, the middle finger on the support projecting portion 10b of the projecting portion 10 from below, and holds the first accessory 1A by the index finger and the middle finger (see FIG. 18).

Since the grip portion 35 is formed to have an annular shape, the insertion hole 35a in which a finger is to be inserted is formed in the grip portion 35, and it is possible to hold the first accessory 1A in the state where the finger is inserted in the grip portion 35. Therefore, it is possible to secure a favorable holding property with respect to the first accessory 1A, and prevent the first accessory 1A, the imaging apparatus 150, and the control apparatus 200 from falling off.

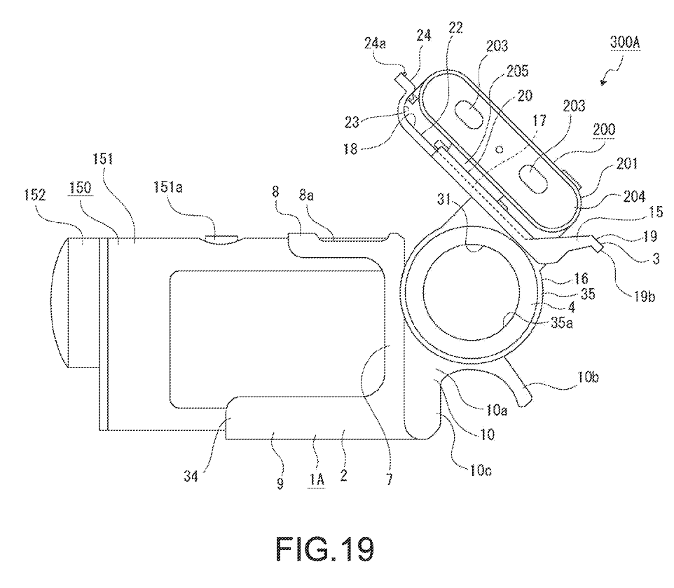

By placing the thumb on the finger hanging operation portion 19b of the apparatus mounting portion 15 from above in the state where the first accessory 1A is held by the index finger and the middle finger as described above, and pressing the finger hanging operation portion 19b downward, it is possible to rotate the apparatus mounting portion 15 with respect to the camera attachment portion 34. The rotation of the apparatus mounting portion 15 can be performed up to a second rotation position where the engaging claw 30a of the other sliding engaging portions 30 in the rotation member 4 is brought into contact with the other stopper projecting portion 12b of the supporting portion 11 in the base member 2, thereby regulating the rotation (see FIG. 19).

When the apparatus mounting portion 15 is rotated, the movable member 3 and the rotation member 4 are integrally rotated with respect to the base member 2 in a state where the annular portion 27 of the rotation member 4 is in sliding contact with the O-ring 33. Therefore, it is possible to hold the apparatus mounting portion 15 at an arbitrary position in the middle of rotation by the friction that occurs between the annular portion 27 and the O-ring 33, and the user is capable of holding the control apparatus 200 in a desired inclined state by rotating the apparatus mounting portion 15 to a necessary rotation angle.

The user is capable of visually checking an image, video, or the like displayed on the display control unit 202 of the control apparatus 200, and operating the operation buttons 203, 203, . . . in the state of holding the control apparatus 200 in a desired inclined state by rotating the apparatus mounting portion 15 as described above.

Meanwhile, in the case of rotating the apparatus mounting portion 15 from the second rotation position to the first rotation position, the user is capable of rotating the apparatus mounting portion 15 with respect to the camera attachment portion 34 by, for example, placing the finger on the finger hanging operation portion 19b from below and pressing the finger hanging operation portion 19b upward.

Since the grip portion 35 to be held by the finger is provided in the first accessory 1A as described above, it is possible to use the control apparatus 200 by holding the grip portion 35 by the finger in the state where the imaging apparatus 150 is attached to the camera attachment portion 34, and use the control apparatus 200 depending on the imaging situation of the imaging apparatus 150, thereby improving the usability of the control apparatus 200 at the time of imaging.

Further, since the grip portion 35 can be held by the finger in the state where the imaging apparatus 150 is attached to the camera attachment portion 34 and the control apparatus 200 is mounted on the apparatus mounting portion 15 in the first accessory 1A, it is possible to improve the functionality of the first accessory 1A depending on the imaging situation of the imaging apparatus 150.

Further, the apparatus mounting portion 15 can be rotated with respect to the camera attachment portion 34, and the orientation of the control apparatus 200 with respect to the imaging apparatus 150 is changed by the rotation of the apparatus mounting portion 15.

Therefore, since the orientation of the control apparatus 200 with respect to the imaging apparatus 150 is changed by the rotation of the apparatus mounting portion 15 with respect to the camera attachment portion 34, it is possible to improve the usability of the control apparatus 200 by setting the control apparatus 200 in a desired orientation.

Further, since the orientation of the control apparatus 200 with respect to the imaging apparatus 150 is changed by the rotation of the apparatus mounting portion 15 with respect to the camera attachment portion 34 in the first accessory 1A, it is possible to improve the usability of the first accessory 1A by setting the control apparatus 200 in a desired orientation.

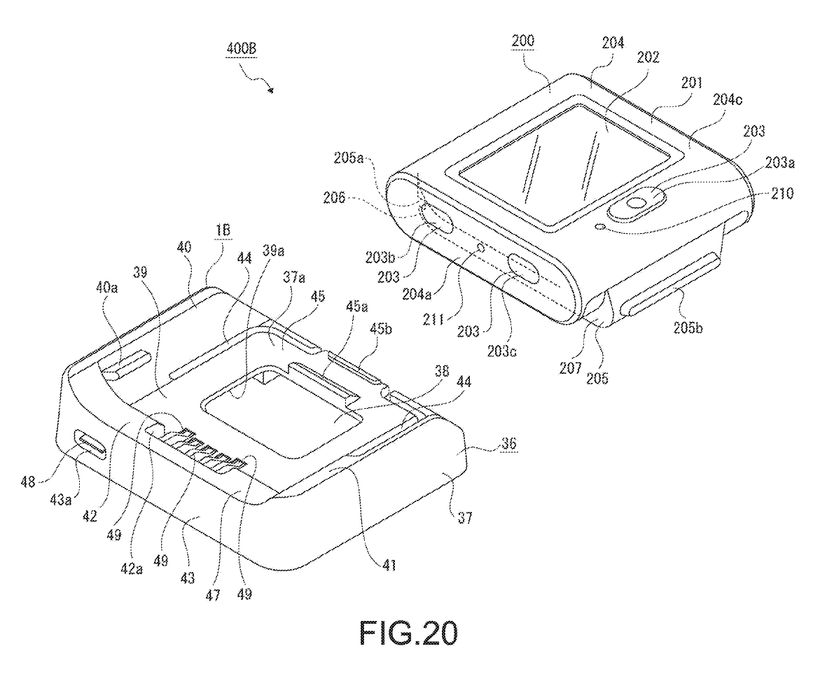

Next, a configuration, etc. of the second accessory 1B will be described (see FIG. 20 to FIG. 22).

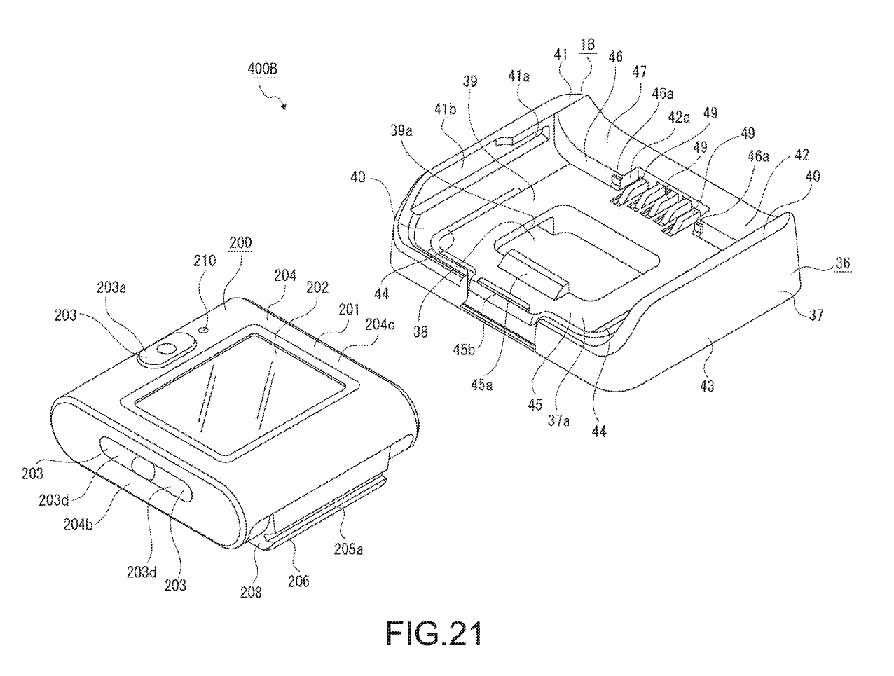

The second accessory 1B is used as, for example, a charging apparatus for the control apparatus 200, and includes necessary respective portions placed in an external casing 36 (see FIG. 20 and FIG. 21). The external casing 36 includes a case body 37 formed to have a shape opened upward, and a bottom plate 38 coupled to the lower end portion of the case body 37.

The case body 37 includes a bottom wall portion 39 located to face the bottom plate 38, a front wall portion 40 continuously provided to the front end portion of the bottom wall portion 39, a rear wall portion 41 continuously provided to the rear end portion of the bottom wall portion 39, a side wall portion 42 continuously provided to the left end portion of the bottom wall portion 39, and a peripheral surface portion 43 located on the outer peripheral side of the bottom wall portion 39.

In the case body 37, a recessed portion surrounded by the bottom wall portion 39, the front wall portion 40, the rear wall portion 41, and the side wall portion 42 is formed. This recessed portion is formed as a mounting recessed portion 37a opened upward and rightward.

The bottom wall portion 39 is located above the bottom plate 38, and has an opening 39a penetrating in the vertical direction at the substantially central part thereof. In the case body 37, a slit 44 that is opened leftward around the bottom wall portion 39 and has a square U shape is formed, and a part surrounded by the slit 44 is provided as an elastic deformation portion 45. The elastic deformation portion 45 is a portion including the opening 39a, provided as a part of the bottom wall portion 39, and elastically deformable in the direction in which the right end portion thereof is displaced in the vertical direction.

In the right opening edge of the opening 39a in the elastic deformation portion 45, a locking projecting portion 45a that projects upward and extends in the longitudinal direction is provided. In the right end portion of the upper surface of the elastic deformation portion 45, an anti-slip projecting portion 45b that projects upward and extends in the longitudinal direction is provided.

The front wall portion 40 projects upward from the front end portion of the bottom wall portion 39, and the left end portion thereof is continuous to the front end portion of the side wall portion 42. In the upper end portion of the left end portion of the front wall portion 40, a locking portion 40a is provided. The locking portion 40a is formed to have a shape that projects rearward and extends in the lateral direction.

The rear wall portion 41 projects upward from the rear end portion of the bottom wall portion 39, and the left end portion thereof is continuous to the rear end portion of the side wall portion 42. In the upper end portion of the left end portion of the rear wall portion 41, an engaging groove 41a is formed. The engaging groove 41a is formed to have a shape penetrating in the longitudinal direction. In the rear wall portion 41, an insertion groove 41b that extends in the lateral direction is formed. The insertion groove 41b penetrates in the longitudinal direction and is opened rightward, and the left end thereof is communicated with the engaging groove 41a.

The side wall portion 42 includes a vertical wall surface portion 46 that projects upward from the left end portion of the bottom wall portion 39, and a top surface portion 47 that projects leftward from the upper end portion of the vertical wall surface portion 46. In the central part in the longitudinal direction of the side wall portion 42, an arrangement recessed portion 42a opened upward and rightward is formed.

In the vertical wall surface portion 46, support projections 46a, 46a are provided on the front side and the rear side of the arrangement recessed portion 42a.

The upper end portion of the peripheral surface portion 43 is continuous to the right end portion of the bottom wall portion 39, the upper end portion of the front wall portion 40, the upper end portion of the rear wall portion 41, and the left end portion of the top surface portion 47, and the lower end portion of the peripheral surface portion 43 is coupled to the outer peripheral portion of the bottom plate 38. On the left side surface portion of the peripheral surface portion 43, an insertion hole 43a is formed. In the insertion hole 43a, a connecter terminal 48 is placed. The connecter terminal 48 is a terminal to which a cable is to be connected at the time of charging.

In the arrangement recessed portion 42a of the side wall portion 42, terminal portions 49, 49 are arranged in the longitudinal direction. To the terminal portions 49, 49, an end portion of the connecter terminal 48 is connected inside the case body 37. The terminal portions 49, 49 can be elastically deformed in the vertical direction.

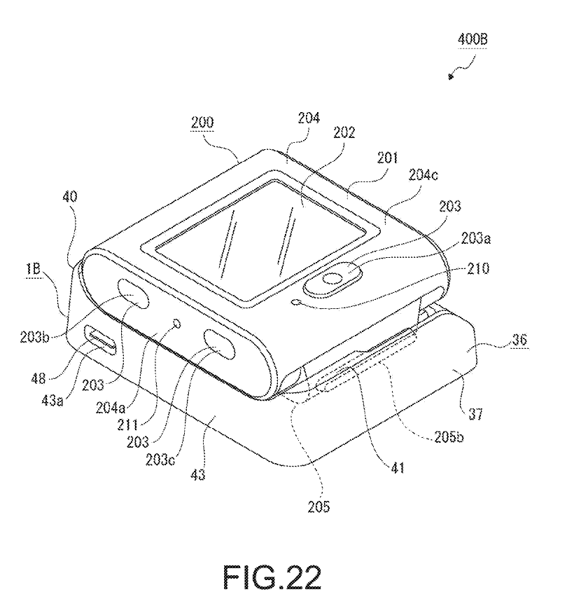

In the second accessory 1B configured as described above, by mounting the control apparatus 200 on the second accessory 1B while the imaging apparatus 150 is not attached to the second accessory 1B, the second accessory 1B and the control apparatus 200 constitute a control unit 400B (see FIG. 22).

Mounting of the control apparatus 200 on the second accessory 1B will be described below.

The control apparatus 200 is mounted on the second accessory 1B by being slid on the second accessory 1B.

The control apparatus 200 is slid leftward on the second accessory 1B, the to-be-mounted projecting portion 205 is inserted and slid between the front wall portion 40 and the rear wall portion 41, the sliding presses the locking projecting portion 45a downward by the to-be-mounted projecting portion 205, and the elastic deformation portion 45 is elastically deformed in the direction in which the locking projecting portion 45a is displaced downward.

When the control apparatus 200 is slid, the lower surface of the to-be-mounted projecting portion 205 is slid on the locking projecting portion 45a. At this time, in the control apparatus 200, the engaging projecting portion 205b is inserted in the engaging groove 41a from the insertion groove 41b, the locking portion 40a is inserted in the engaging recessed portion 205a.

When the control apparatus 200 is further slid to the left, the to-be-mounted projecting portion 205 is located on the left of the locking projecting portion 45a, the elastic deformation portion 45 is elastically restored, and the locking projecting portion 45a is engaged with the second contact portion 208a. The engaging projecting portion 205b is engaged with the engaging groove 41a, the engaging recessed portion 205a is engaged with the locking portion 40a, the locking projecting portion 45a is engaged with the second contact portion 208a, and thus, the control apparatus 200 is mounted on the second accessory 1B.

When the control apparatus 200 is slid and mounted on the second accessory 1B, the connection terminals 209, 209, . . . of the control apparatus 200 are slid on the terminal portions 49, 49, . . . .

Therefore, since the dust adhered to the connection terminals 209, 209, . . . and the terminal portions 49, 49, . . . is removed by the sliding, it is possible to prevent dust from being adhered to the connection terminals 209, 209, . . . and the terminal portions 49, 49, . . . .

Further, since the dust adhered to the connection terminals 209, 209, . . . is removed by the sliding, for example, it is not necessary to provide a lid member for preventing adhesion or entry of dust, so that it is possible to reduce the number of parts of the control apparatus 200 and the size of the control apparatus 200 by that much.

In the state where the control apparatus 200 is mounted on the second accessory 1B, the to-be-mounted projecting portion 205 is inserted in the mounting recessed portion 37a formed in the second accessory 1B.

Therefore, since the control apparatus 200 is mounted on the second accessory 1B in the state where the to-be-mounted projecting portion 205 is inserted in the mounting recessed portion 37a, it is possible to secure a stable mounted state with respect to the second accessory 1B. Also, since the main body portion 204 is not inserted in the mounting recessed portion 37a, a favorable visibility for the display control unit 202 can be secured.

In particular, since the to-be-mounted projecting portion 205 is inserted in the mounting recessed portion 37a, the control apparatus 200 is hardly slid on the second accessory 1B, making it possible to prevent the control apparatus 200 from falling off from the second accessory 1B.

Further, since the to-be-mounted projecting portion 205 is inserted in the mounting recessed portion 37a, it is possible to reduce the overall size of the second accessory 1B.

Further, the engaging projecting portion 205b and the engaging recessed portion 205a are formed in the to-be-mounted projecting portion 205, and the to-be-mounted projecting portion 205 is inserted in the mounting recessed portion 37a in the state where the control apparatus 200 is mounted on the second accessory 1B.

Therefore, since the control apparatus 200 is mounted on the second accessory 1B in the state where the to-be-mounted projecting portion 205 is inserted in the mounting recessed portion 37a, the engaging projecting portion 205b and the engaging recessed portion 205a are closed by the second accessory 1B, a hand does not accidentally come into contact with the engaging projecting portion 205b and the engaging recessed portion 205a in the state where the control apparatus 200 is mounted on the second accessory 1B, and thus, it is possible to prevent the control apparatus 200 from unintentionally falling off from the second accessory 1B.

Further, the engaging projecting portion 205b is engaged with the engaging groove 41a that is a recessed portion, the engaging recessed portion 205a is engaged with the locking portion 40a that is a projecting portion of the second accessory 1B, and thus, the control apparatus 200 is mounted on the second accessory 1B.

Therefore, since the control apparatus 200 can be mounted on the second accessory 1B only in a state where the engaging projecting portion 205b and the engaging recessed portion 205a are in a positional relationship corresponding to the engaging groove 41a and the locking portion 40a, respectively, the control apparatus 200 is mounted always in a predetermined orientation on the second accessory 1B, and it is possible to prevent the control apparatus 200 from being mounted in a wrong orientation on the second accessory 1B.

In the state where the control apparatus 200 is mounted on the second accessory 1B, the support projections 46a, 46a of the vertical wall surface portion 46 are brought into contact with the first contact portions 207a, 207a.

Therefore, since the casing 201 is supported by the support projections 46a, 46a in a state of being point-contacted at two points, rattling of the control apparatus 200 with respect to the second accessory 1B is suppressed, and the control apparatus 200 is mounted in a stable state on the second accessory 1B.

Further, at this time, the projecting portion for terminal 205c of the to-be-mounted projecting portion 205 is inserted in the arrangement recessed portion 42a formed in the side wall portion 42. Therefore, since any part other than the terminal portions 49, 49, . . . does not come into contact with the connection terminals 209, 209, . . . , it is possible to prevent the connection terminals 209, 209, . . . from being scratched or damaged.

By connecting the cable connected to the power source to the connecter terminal in the state where the control apparatus 200 is mounted on the second accessory 1B, it is possible to charge the control apparatus 200.

When a pressing operation is performed on the right end portion of the elastic deformation portion 45 in the lower direction in the state where the control apparatus 200 is mounted on the second accessory 1B, the elastic deformation portion 45 is elastically deformed in the direction in which the locking projecting portion 45a is displaced downward, and engagement of the locking projecting portion 45a with the second contact portion 208a is released. Therefore, by sliding the control apparatus 200 rightward, it is possible to detach the control apparatus 200 from the second accessory 1B.

At this time, it is possible to place the finger on the anti-slip projecting portion 45b to perform an operation of displacing the elastic deformation portion 45 downward, and slipping of the finger on the elastic deformation portion 45 is suppressed, making it possible to reliably performing an operation of detaching the control apparatus 200 from the second accessory 1B.

Since the mounting of the control apparatus 200 on the second accessory 1B is performed by the elastic deformation of the elastic deformation portion 45 of the second accessory 1B when the control apparatus 200 is slid as described above, it is possible to mount the control apparatus 200 on the second accessory 1B by a simple method.

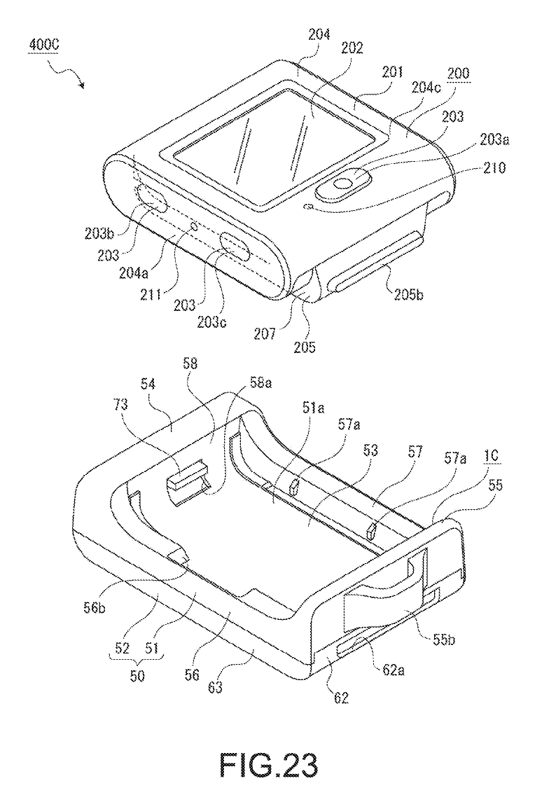

Next, a configuration, etc. of the third accessory 1C will be described (see FIG. 23 to FIG. 30).

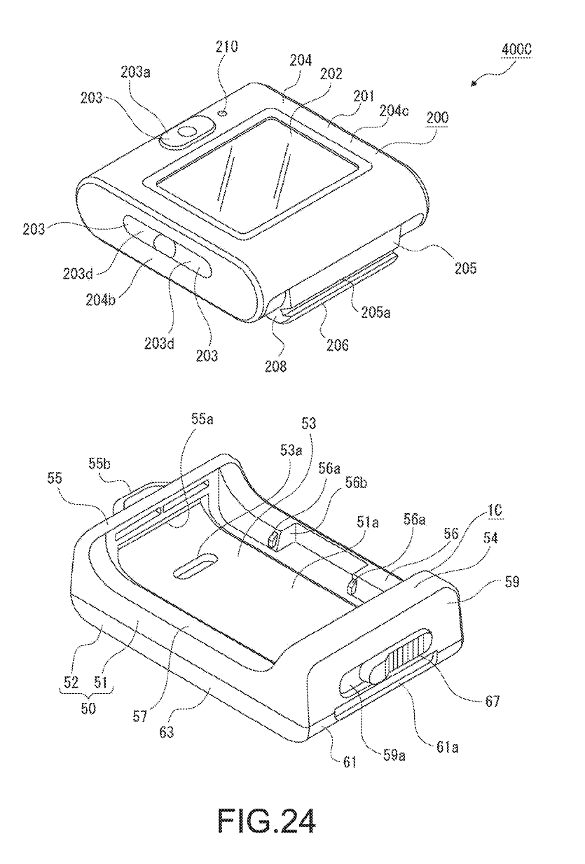

The third accessory 1C is, for example, mounted on another part or another portion and used, and includes necessary respective portions placed in an external casing 50 (see FIG. 23 and FIG. 24). The external casing 50 is formed by vertically coupling an upper case 51 formed to have a shape having a recessed portion opened upward and a lower case 52 having a shallow box shape opened upward to each other.

The recessed portion of the upper case 51 is formed as a mounting recessed portion 51a.

The upper case 51 includes a bottom wall portion 53 directed in the vertical direction, a front wall portion 54 that projects upward from the front end portion of the bottom wall portion 53, a rear end portion 55 that projects upward from the rear end portion of the bottom wall portion 53, a left side wall portion 56 that projects upward from the left end portion of the bottom wall portion 53, and a right side wall portion 57 that projects upward from the right end portion of the bottom wall portion 53.

In the rear end portion of the bottom wall portion 53, a weep hole 53a is formed.

The front wall portion 54 is formed to have a horizontally long box shape opened downward, and includes a rear surface wall 58 and a front surface wall 59 placed to face each other. In the rear surface wall 58, an insertion hole 58a is formed. In the front wall surface 59, a horizontally long slide recessed portion 59a opened forward is formed. In the front wall surface 59, a horizontally long through hole 59b communicated with the slide recessed portion 59a is formed.

In the rear end portion 55, an engaging groove 55a that is opened forward and extends in the lateral direction is formed. In the rear end portion 55, a strap mounting portion 55b that projects rearward is provided. By mounting a strap (not shown) in the strap mounting portion 55b, it is possible to hold the third accessory 1C via the strap.

In the inner surface of the left side wall portion 56, support projections 56a, 56a are provided apart from each other in the longitudinal direction. In the central part in the longitudinal direction of the left side wall portion 56, an arrangement recessed portion 56b opened upward and rightward is formed at a position between the support projections 56a, 56a.

In the inner surface of the right side wall portion 57, support projections 57a, 57a are provided apart from each other in the longitudinal direction.

The lower case 52 includes a bottom surface 60 directed in the vertical direction, a front surface portion 61 that projects upward from the front end portion of the bottom surface 60, a rear surface portion 62 that projects upward from the rear end portion of the bottom surface 60, and side surface portions 63, 63 that project upward from the right and left end portions of the bottom surface 60.

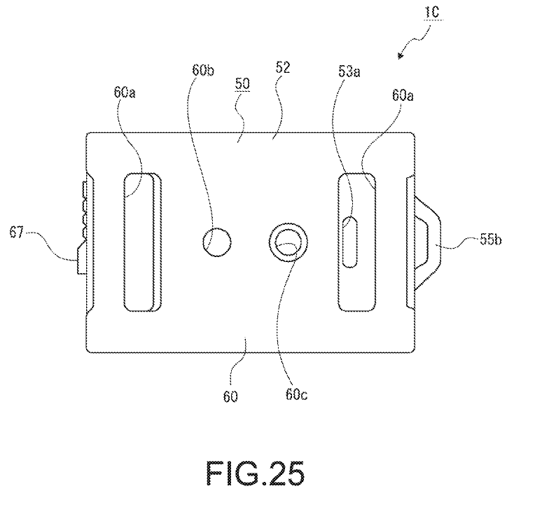

In the front and rear end portions of the bottom surface 60, horizontally long belt insertion holes 60a, 60a are formed (see FIG. 25). One of the belt insertion holes 60a, 60a is located below the weep hole 53a formed in the bottom wall portion 53 of the upper case 51. In the bottom surface 60, a positioning hole 60b and a screw hole 60c are formed apart from each other in the longitudinal direction. The positioning hole 60b and the screw hole 60c are located between the belt insertion holes 60a, 60a.

A horizontally long belt insertion hole 61a is formed in the front surface portion 61, and a horizontally long belt insertion hole 62a is formed in the rear surface portion 62.

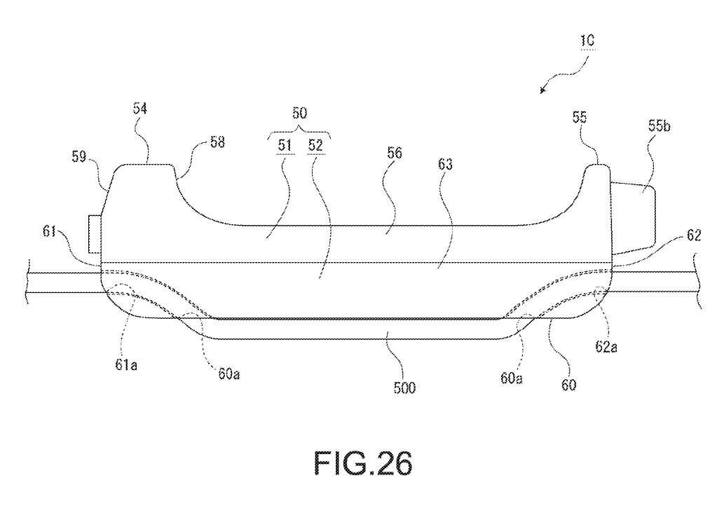

In the third accessory 1C, a belt 500 with a hook-and-loop fastener is inserted through, for example, the belt insertion holes 61a, 60a, 60a, and 62a in the stated order (see FIG. 26). By inserting the belt 500 through the third accessory 1C, it is possible to mount the third accessory 1C on a part of a human body such as an arm, an ornament mounted on the body, or the like, via the belt 500 for use.

Further, the third accessory 1C can be mounted also on, for example, a tripod. The mounting of the third accessory 1C on a tripod can be performed by screwing a mounting screw provided in a mounting portion of the tripod to the screw hole 60c in the state where a positioning pin provided in a mounting portion of the tripod is inserted in the positioning hole 60b and positioned.

Note that when mounting the third accessory 1C on the tripod for use in the state where the control apparatus 200 is mounted on the third accessory 1C, a part of the mounting portion of the tripod is located directly below the imaging button 203a of the control apparatus 200. Therefore, the control apparatus 200 does not rattle with respect to the mounting portion of the tripod when operating the imaging button 203a, and it is possible to secure a favorable operability of the imaging button 203a.

Further, the third accessory 1C is mounted on, for example, an adapter (not shown), the adapter is mounted on a handle or the like of a bicycle or the like, and thus, the third accessory 1C is mounted on the handle or the like via the adapter for use. Description of the mounting of the third accessory 1C on the adapter is omitted because it is similar to the mounting of the tripod on the mounting portion.

The mounting of the third accessory 1C on the handle or the like via the adapter is performed generally in the state where the control apparatus 200 is inclined forward and upward in order to secure a high visibility or a high operability of the control apparatus 200 for a passenger. When mounting the third accessory 1C on the handle or the like, the third accessory 1C and the control apparatus 200 are used outdoors, and rainwater enters the mounting recessed portion 51a of the third accessory 1C in the rainfall situation. The entered rain is discharged from the weep hole 53a to the outside through one of the belt insertion holes 60a, 60a or the belt insertion hole 62a.

Since the weep hole 53a is formed in the third accessory 1C as described above, rainwater is discharged from the weep hole 53a in the rainfall situation, and the control apparatus 200 can be used also in rainy weather, thereby improving the usability of the control apparatus 200.

Further, rainwater does not accumulate in the third accessory 1C even in the state where the third accessory 1C is left outdoors while being mounted on the handle or the like, and thus, it is possible to improve the usability of the third accessory 1C.

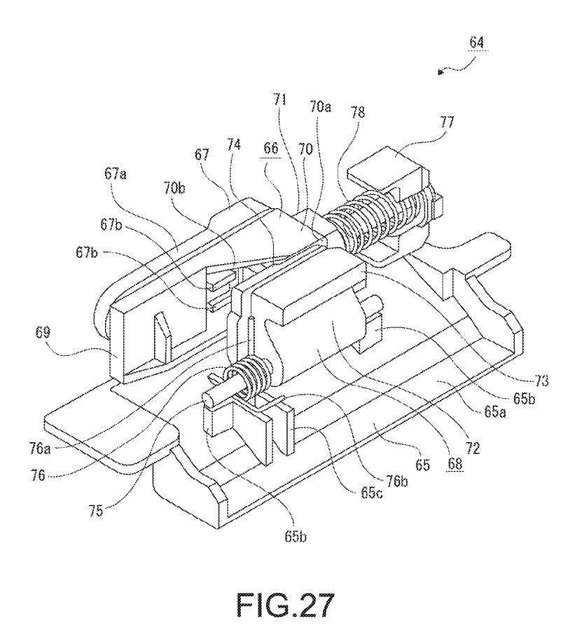

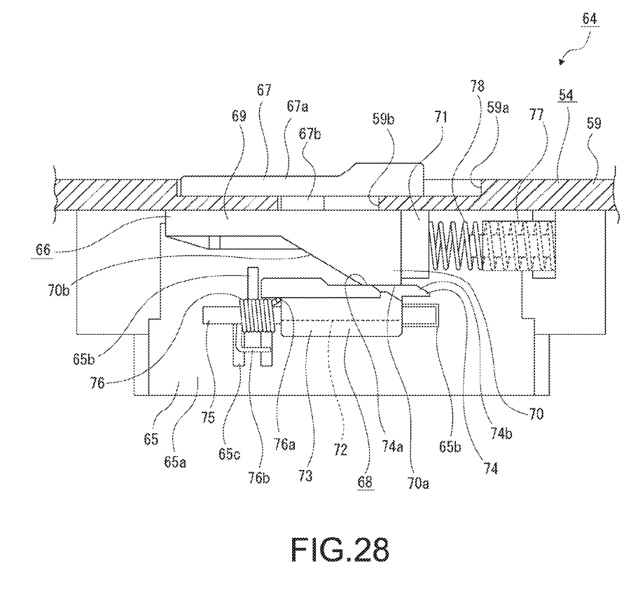

In the third accessory 1C, a portion of a locking mechanism 64 excluding a part thereof is placed in the internal space surrounded by the front wall portion 54 and the front end portion of the lower case 52 (see FIG. 27 and FIG. 28). The locking mechanism 64 includes a base 65, an operation member 66, a slide knob 67, and a lock lever 68.

The base 65 is mounted on the inner surface of the front end portion of the lower case 52, and includes a base plate portion 65a formed to have a horizontally long shape, shaft supporting portions 65b, 65b that project upward from the base plate portion 65a and are located apart from each other in the lateral direction, and a spring supporting projecting portion 65c continuously provided to one of the shaft supporting portions 65b, 65b.

The operation member 66 is formed to have a horizontally long shape, and movable in the lateral direction. The operation member 66 includes a coupling plate portion 69 formed to have a horizontally long and substantially rectangular shape, the operation portion 70 that projects rearward from the right half portion of the coupling plate portion 69, and a spring reception portion 71 that projects rightward from the coupling plate portion 69 and the operation portion 70. The tip surface of the operation portion 70 is formed as a rotation regulation surface 70a directed rearward. In the operation portion 70, an inclined surface 70b that approaches the coupling plate portion 69 as it goes to the left side from the rotation regulation surface 70a.

The slide knob 67 includes an to-be-operated portion 67a formed to have a horizontally long shape, and coupling projection portions 67b, 67b that project rearward from the to-be-operated portion 67a. In the slide knob 67, the to-be-operated portion 67a is placed on the slide recessed portion 59a formed on the front wall surface 59 of the upper case 51, and the coupling projection portions 67b, 67b are inserted through the through hole 59b communicated with the slide recessed portion 59a and coupled to the coupling plate portion 69 of the operation member 66. Therefore, the front wall surface 59 is sandwiched between the slide knob 67 and the operation member 66 from both sides, and the slide knob 67 and the operation member 66 are integrally movable in the lateral direction with respect to the front wall surface 59.

The lock lever 68 includes a to-be-supported portion 72, a locking portion 73 that projects rearward from the upper end portion of the to-be-supported portion 72, and an to-be-operated portion 74 provided at the front side of the to-be-supported portion 72 and the locking portion 73. On the front surface side of the to-be-operated portion 74, a to-be-regulated surface 74a directed forward and a slope 74b that is displaced rearward as it goes rightward from the to-be-regulated surface 74a are formed. The lock lever 68 is formed so that the locking portion 73 can be inserted through the insertion hole 58a formed in the rear surface wall 58 of the upper case 51.

The lock lever 68 is rotatable with a supporting shaft 75 as a fulcrum. The supporting shaft 75 extends in the lateral direction and penetrates the lower end portion of the to-be-supported portion 72, and both end portions thereof are supported by the shaft supporting portions 65b, 65b of the base 65. Therefore, the lock lever 68 is rotated in the direction in which the locking portion 73 enters and leaves the insertion hole 58a.

By one end portion of the supporting shaft 75, a torsion coil spring 76 is supported. One end portion 76a of the torsion coil spring 76 is engaged with the to-be-operated portion 74 of the lock lever 68 from behind, and other end portion 76b is engaged with the shaft supporting projecting portion 65b of the base 65 from above. Therefore, the lock lever 68 is biased in the direction in which the locking portion 73 is moved substantially forward by the torsion coil spring 76.

On the right end portion of the base plate portion 65a of the base 65, a spring supporting member 77 is mounted. By the spring supporting member 77, a compression coil spring 78 is supported. The left end portion of the compression coil spring 78 is pressed by the spring reception portion 71 of the operation member 66 from the right side. Therefore, the operation member 66 and the slide knob 67 are biased leftward by the compression coil spring 78.

In the locking mechanism 64 configured as described above, the operation member 66 and the slide knob 67 are located at the left moving end by the biasing force of the compression coil spring 78 in a state where the slide knob 67 is not operated (see FIG. 28). At this time, the rotation regulation surface 70a of the operation member 66 is in a state of being in contact with the to-be-regulated surface 74a of the lock lever 68, the lock lever 68 is held at the rear rotation end, and the locking portion 73 projects rearward from the insertion hole 58a (see FIG. 23).

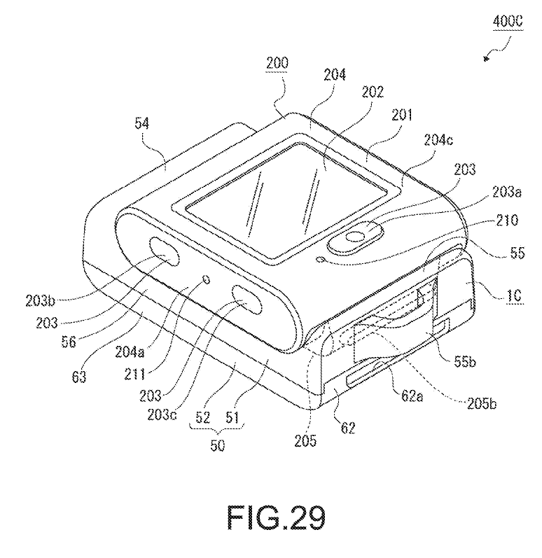

In the third accessory 1C configured as described above, by mounting the control apparatus 200 on the third accessory 1C while the imaging apparatus 150 is not attached to the third accessory 1C, the third accessory 1C and the control apparatus 200 constitute a control unit 400C (see FIG. 29).

Mounting of the control apparatus 200 on the third accessory 1C will be described below.

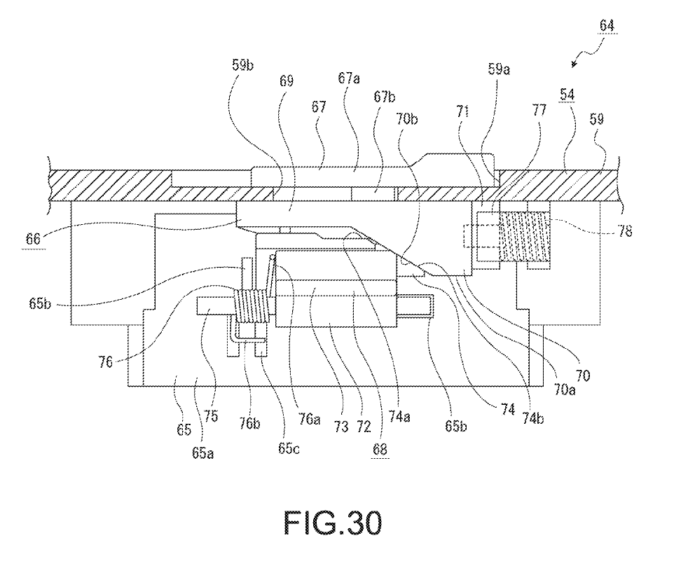

When mounting the control apparatus 200 on the third accessory 1C, first, a slide operation is performed on the slide knob 67 to the right side against the biasing force of the compression coil spring 78 (see FIG. 30). When the slide knob 67 is slid rightward, the rotation regulation surface 70a of the operation member 66 is slid on the slope 74b of the lock lever 68, the lock lever 68 is rotated in the direction of approaching the operation member 66 by the biasing force of the torsion coil spring 76, and the locking portion 73 that has projected rearward from the insertion hole 58a is drawn into the insertion hole 58a.

Next, in the state where the locking portion 73 is drawn in to the insertion hole 58a, the control apparatus 200 is inserted in the third accessory 1C between the front wall portion 54 and the rear end portion 55 from above in a state of being inclined forward and upward, and the engaging projecting portion 205b is inserted in the engaging groove 55a. In the state where the engaging projecting portion 205b is inserted in the engaging groove 55a, the front end potion of the control apparatus 200 is pushed down, and the control apparatus 200 is inserted in the mounting recessed portion 51a.

At this time, the to-be-guided inclined surfaces 207 and 208 are formed in the to-be-mounted projecting portion 205 of the control apparatus 200, the to-be-guided inclined surfaces 207 and 208 are respectively slidable on the inner edge of the left side wall portion 56 and the inner edge of the right side wall portion 57 when the front end portion of the control apparatus 200 is pushed down, and thus, the to-be-mounted projecting portion 205 is inserted in the mounting recessed portion 51a.

Therefore, it is possible to easily and reliably insert the to-be-mounted projecting portion 205 in the mounting recessed portion 51a.

Next, the state of operating the slide knob 67 to the right side is released, and the slide knob 67 and the operation member 66 are slid on the left side by the biasing force of the compression coil spring 78. When the operation member 66 is slid leftward, the rotation regulation surface 70a of the operation member 66 is slid on the slope 74b of the lock lever 68, the lock lever 68 is rotated in the direction away from the slide knob 67 against the biasing force of the torsion coil spring 76, and thus, the locking portion 73 projects rearward from the insertion hole 58a.

Therefore, the locking portion 73 is inserted in and engaged with the engaging recessed portion 205a of the control apparatus 200 inserted in the mounting recessed portion 51a, and thus, the control apparatus 200 is mounted on the third accessory 1C.

In the state where the control apparatus 200 is mounted on the third accessory 1C, the to-be-mounted projecting portion 205 is inserted in the mounting recessed portion 51a formed in the third accessory 1C.

Therefore, since the control apparatus 200 is mounted on the third accessory 1C in the state where the to-be-mounted projecting portion 205 is inserted in the mounting recessed portion 51a, it is possible to secure a stable mounted state with respect to the third accessory 1C. Also, since the main body portion 204 is not inserted in the mounting recessed portion 51a, a favorable visibility for the display control unit 202 can be secured.

In particular, since the to-be-mounted projecting portion 205 is inserted in the mounting recessed portion 51a, the control apparatus 200 is hardly slid on the third accessory 1C, making it possible to prevent the control apparatus 200 from falling off from the third accessory 1C.

Further, since the to-be-mounted projecting portion 205 is inserted in the mounting recessed portion 51a, it is possible to reduce the overall size of the third accessory 1C.

Further, the engaging projecting portion 205b and the engaging recessed portion 205a are formed in the to-be-mounted projecting portion 205, and the to-be-mounted projecting portion 205 is inserted in the mounting recessed portion 51a in the state where the control apparatus 200 is mounted on the third accessory 1C.

Therefore, since the control apparatus 200 is mounted on the third accessory 1C in the state where the to-be-mounted projecting portion 205 is inserted in the mounting recessed portion 51a, the engaging projecting portion 205b and the engaging recessed portion 205a are closed by the third accessory 1C, a hand does not accidentally come into contact with the engaging projecting portion 205b and the engaging recessed portion 205a in the state where the control apparatus 200 is mounted on the third accessory 1C, and thus, it is possible to prevent the control apparatus 200 from unintentionally falling off from the third accessory 1C.

Further, the engaging projecting portion 205b is engaged with the engaging groove 55a that is a recessed portion, the engaging recessed portion 205a is engaged with the locking portion 73 that is a projecting portion of the third accessory 1C, and thus, the control apparatus 200 is mounted on the third accessory 1C.

Therefore, since the control apparatus 200 can be mounted on the third accessory 1C only in a state where the engaging projecting portion 205b and the engaging recessed portion 205a are in a positional relationship corresponding to the engaging groove 55a and the locking portion 73, respectively, the control apparatus 200 is mounted always in a predetermined orientation on the third accessory 1C, and it is possible to prevent the control apparatus 200 from being mounted in a wrong orientation on the third accessory 1C.

In the state where the control apparatus 200 is mounted on the third accessory 1C, the support projections 56a, 56a of the left side wall portion 56 are brought into contact with the first contact portions 207a, 207a, and the support projections 57a, 57a of the right side wall portion 57 are brought into contact with the second contact portion 208a.

Therefore, the casing 201 is supported by the support projections 56a, 56a, 57a, and 57a in a state of being point-contacted at four points, rattling of the control apparatus 200 with respect to the third accessory 1C is suppressed, and the control apparatus 200 is mounted in a stable state on the third accessory 1C.

Further, at this time, the projecting portion for terminal 205c of the to-be-mounted projecting portion 205 is inserted in the arrangement recessed portion 56b formed by the left side wall portion 56. Therefore, since any part of the third accessory 1C does not come into contact with the connection terminals 209, 209, . . . , it is possible to prevent the connection terminals 209, 209, . . . from being scratched or damaged.

Note that an example in which a slide operation is performed on the slide knob 67 to the right side when mounting the control apparatus 200 on the third accessory 1C, then, the control apparatus 200 is inserted in the mounting recessed portion 51a, then, the state of operating the slide knob 67 to the right side is released, the locking portion 73 is inserted in and engaged with the engaging recessed portion 205a, and thus, the control apparatus 200 is mounted on the third accessory 1C has been described above.

However, the control apparatus 200 may be mounted on the third accessory 1C by inserting the control apparatus 200 in the mounting recessed portion 51a in the state where a slide operation is not performed on the slide knob 67 to the right side.

In this case, when the control apparatus 200 is inserted in the mounting recessed portion 51a, the locking portion 73 is pressed forward by the sliding contact surface 206 to rotate the lock lever 68 in the direction of approaching the slide knob 67, and thus, the locking portion 73 is temporarily drawn into the insertion hole 58a. Further, by inserting the control apparatus 200 in the deep side of the mounting recessed portion 51a, the locking portion 73 is located at a position corresponding to the position of the engaging recessed portion 205a, and the lock lever 68 is rotated in the direction away from the slide knob 67 by the biasing force of the torsion coil spring 76. When the lock lever 68 is rotated in the direction away from the slide knob 67, the locking portion 73 projects rearward from the insertion hole 58a, the locking portion 73 is inserted in and engaged with the engaging recessed portion 205a, and thus, the control apparatus 200 is mounted on the third accessory 1C.

As described above, when a slide operation is performed on the slide knob 67 to the right side against the biasing force of the compression coil spring 78 in the state where the control apparatus 200 is mounted on the third accessory 1C, the lock lever 68 is rotated in the direction approaching the slide knob 67 by the biasing force of the torsion coil spring 76, the locking portion 73 is drawn into the insertion hole 58a, and thus, the locking with respect to the engaging recessed portion 205a is released.

Therefore, by pulling out the engaging projecting portion 205b from the engaging groove 55a, it is possible to detach the control apparatus 200 from the third accessory 1C.

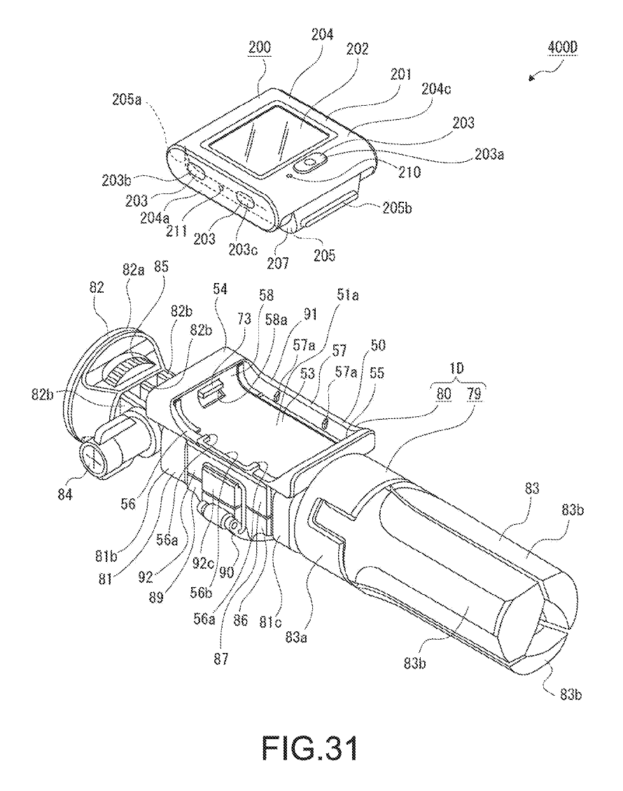

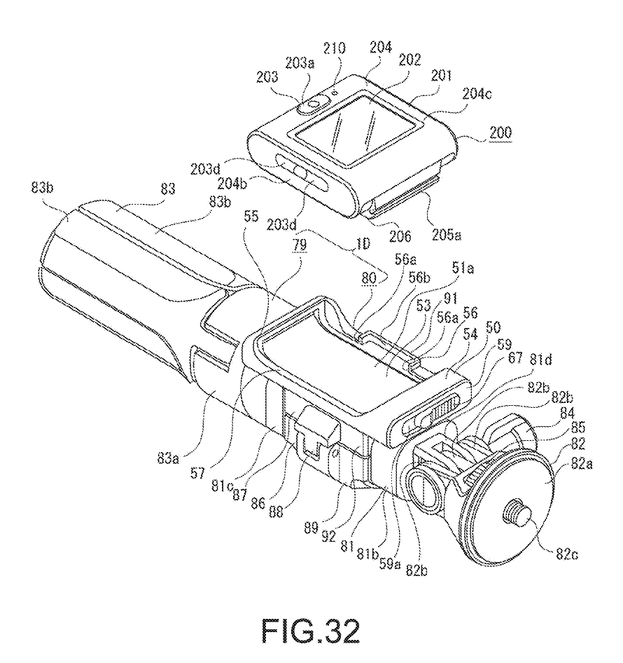

Next, a configuration, etc. of the fourth accessory 1D will be described (see FIG. 31 to FIG. 35).

The fourth accessory 1D is held by a hand and used or used as a tripod, for example, and includes a main body 79 and a mounting portion 80 (see FIG. 31 to FIG. 33).

The main body 79 includes a coupling portion 81, a camera attachment portion 82, and a functional portion 83.

The coupling portion 81 includes a round shaft shaped coupling shaft portion 81a that extends in the longitudinal direction, a first coupling portion 81b provided on the front side of the coupling shaft portion 81a, a second coupling portion 81c provided on the rear side of the coupling shaft portion 81a, a supporting projecting portion 81d that projects forward from the first coupling portion 81b, and positioning projecting portions 81e, 81e, . . . that project from the outer peripheral surface of the coupling shaft portion 81a.

The outer shapes of the first coupling portion 81b and the second coupling portion 81c are larger than the diameter of the coupling shaft portion 81a. The supporting projecting portion 81d projects from the central portion in the lateral direction of the first coupling portion 81b. The positioning projecting portions 81e, 81e, . . . project from both end portions in the axial direction of the coupling shaft portion 81a, and respective two positioning projecting portions 81e, 81e are located apart from each other in the circumferential direction.

The camera attachment portion 82 includes a mounting base 82a formed to have a substantially truncated cone shape, and to-be-supported projecting portions 82b, 82b that project rearward from the mounting base 82a. The to-be-supported projecting portions 82b, 82b are located apart from each other in the lateral direction.

In the camera attachment portion 82, the to-be-supported projecting portions 82b, 82b are rotatably supported by the supporting projecting portion 81d of the coupling portion 81 via an adjustment shaft 84. By performing a rotation operation on the adjustment shaft 84, it is possible to hold the camera attachment portion 82 with respect to the coupling portion 81 at an arbitrary angle.

In the camera attachment portion 82, a mounting screw 82c that projects forward from the central portion of the mounting base 82a is provided. A dial for mounting 85 is supported by the mounting base 82a, and the mounting screw 82c is rotated by performing a rotation operation on the dial for mounting 85. Therefore, by screwing the mounting screw 82c to a screw portion formed on the lower surface of the imaging apparatus 150, it is possible to attach the imaging apparatus 150 to the camera attachment portion 82.

The functional portion 83 includes a supporting base 83a coupled to the second coupling portion 81c, and leg portions 83b, 83b rotatably supported by the supporting base 83a in the range of a certain angle. The upper end portions of the leg portions 83b, 83b are supported by the supporting base 83a.

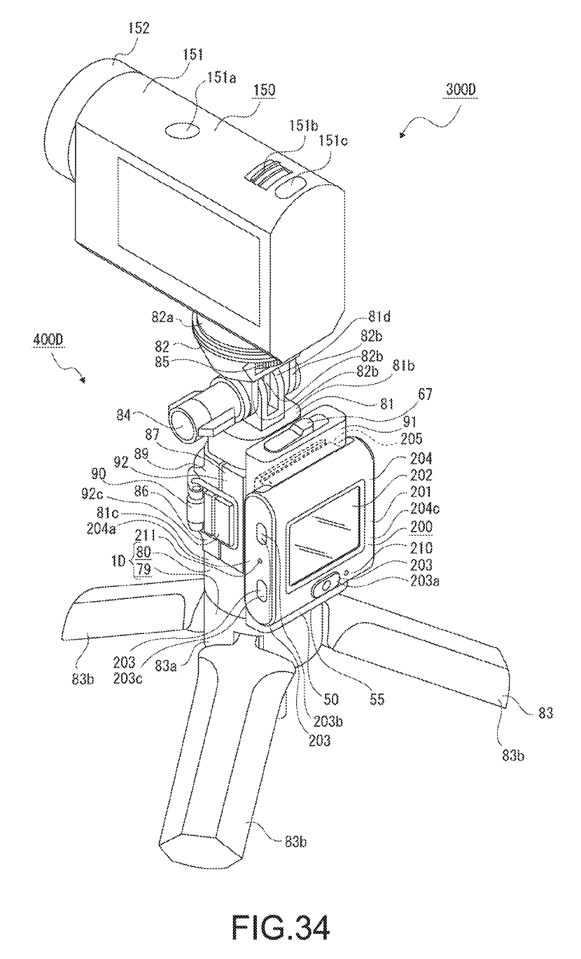

By rotating the leg portions 83b, 83b with respect to the supporting base 83a so as to be in a opened state and placing the lower end portions of the leg portions 83b, 83b on a placing surface, the fourth accessory 1D is used as a tripod (see FIG. 34).

Further, by making the leg portions 83b, 83b in a closed state with respect to the supporting base 83a and holding the functional portion 83 by a hand, it is possible to use the imaging apparatus 150 in an imaging state of a high angle or a low angle, or in taking an image of the photographer himself/herself, i.e., taking a so-called selfie.

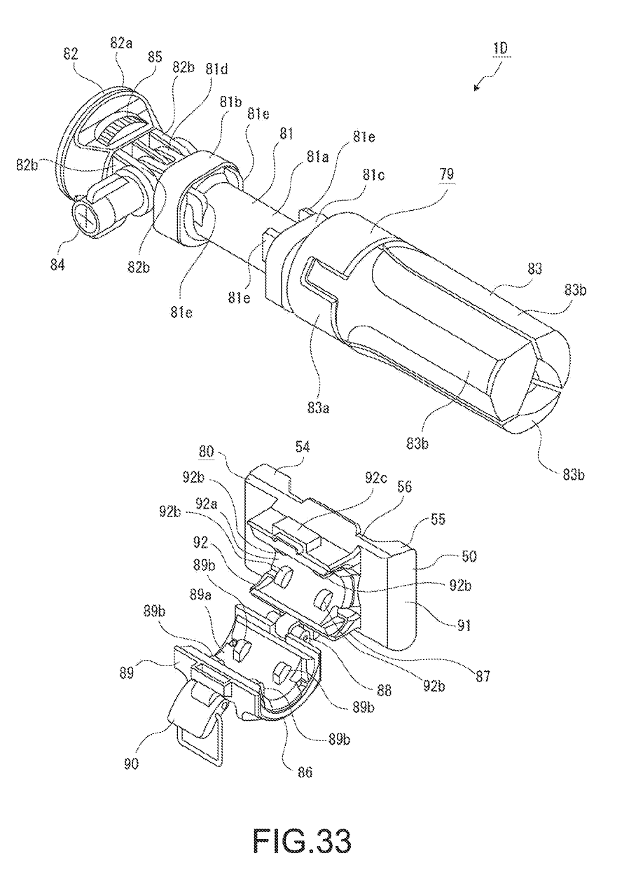

The mounting portion 80 includes a first coupling body 86 and a second coupling body 87, and the first coupling body 86 and the second coupling body 87 are rotatably coupled to each other by a hinge 88 (see FIG. 33). The mounting portion 80 is attachable/detachable to/from the coupling portion 81.

The first coupling body 86 includes a coupling surface portion 89 formed to have a substantially semicircular arc surface shape, and a buckle portion 90 rotatably coupled to the coupling surface portion 89. The coupling surface portion 89 includes an inner 89a formed of rubber or the like on the inner surface side thereof, and projecting portions 89b, 89b are provided in the inner 89a.

The second coupling body 87 includes an apparatus mounting portion 91, and a coupling surface portion 92 that is integrally provided on one surface side of the apparatus mounting portion 91 and has a substantially semicircular arc surface shape. The coupling surface portion 92 includes an inner 92a formed of rubber or the like on the inner surface side thereof, and projecting portions 92b, 92b are provided in the inner 92a. A projecting portion for coupling 92c is provided on the outer peripheral surface of the coupling surface portion 92.

Since the apparatus mounting portion 91 is a portion on which the control apparatus 200 is to be mounted and has a shape and a structure similar to those of the above-mentioned third accessory 1C, description of the apparatus mounting portion 91 will be omitted by applying reference symbols for the third accessory 1C to components similar to those of the third accessory 1C.

In the fourth accessory 1D, the mounting portion 80 can be detached from the main body 79 for use. The mounting portion 80 is, for example, mounted on a handle of a bicycle or the like for use.

The detaching of the mounting portion 80 from the main body 79 can be performed by releasing the coupling state of the buckle portion 90 to the projecting portion for coupling 92c, and rotating the first coupling body 86 and the second coupling body 87 in the direction of opening with the hinge 88 as a fulcrum.

Meanwhile, the mounting of the mounting portion 80 on the main body 79 can be performed by rotating the first coupling body 86 and the second coupling body 87 in the direction of closing with the hinge 88 as a fulcrum and coupling the buckle portion 90 to the projecting portion for coupling 92c while bringing the positioning projecting portions 81e, 81e, . . . into alignment with the projecting portions 92b, 92b.

Also the mounting of the mounting portion 80 on a handle of a bicycle, or the like can be performed by rotating the first coupling body 86 and the second coupling body 87 in the direction of closing with the hinge 88 as a fulcrum and coupling the buckle portion 90 to the projecting portion for coupling 92c.

In the mounting portion 80, the inners 89a and 92a are provided. Therefore, in the state where the mounting portion 80 is mounted on the main body 79, a handle, or the like, rattling of the mounting portion 80 with respect to the main body 79, the handle, or the like is suppressed, and the mounting portion 80 can be mounted in a stable state on the main body 79, the handle, or the like.

In the fourth accessory 1D configured as described above, by attaching the imaging apparatus 150 to the camera attachment portion 82, and mounting the control apparatus 200 on the apparatus mounting portion 91, the fourth accessory 1D, the imaging apparatus 150, and the control apparatus 200 constitute an imaging unit 300D (see FIG. 34).

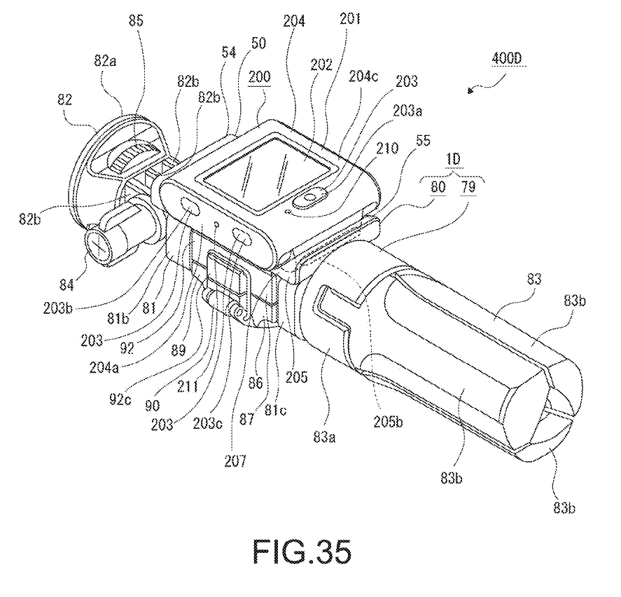

Further, by mounting the control apparatus 200 on the apparatus mounting portion 91 of the mounting portion 80, the fourth accessory 1D and the control apparatus 200 constitute a control unit 400D (see FIG. 35).

In the state where the control apparatus 200 is mounted on the apparatus mounting portion 91 of the fourth accessory 1D, the to-be-mounted projecting portion 205 is inserted in the mounting recessed portion 51a formed in the fourth accessory 1D.

Therefore, since the control apparatus 200 is mounted on the fourth accessory 1D in the state where the to-be-mounted projecting portion 205 is inserted in the mounting recessed portion 51a, it is possible to secure a stable mounted state with respect to the fourth accessory 1D. Also, since the main body portion 204 is not inserted in the mounting recessed portion 51a, a favorable visibility for the display control unit 202 can be secured.

In particular, since the to-be-mounted projecting portion 205 is inserted in the mounting recessed portion 51a, the control apparatus 200 is hardly slid on the fourth accessory 1D, making it possible to prevent the control apparatus 200 from falling off from the fourth accessory 1D.

Further, since the to-be-mounted projecting portion 205 is inserted in the mounting recessed portion 51a, it is possible to reduce the overall size of the fourth accessory 1D.

Further, the engaging projecting portion 205b and the engaging recessed portion 205a are formed in the to-be-mounted projecting portion 205, and the to-be-mounted projecting portion 205 is inserted in the mounting recessed portion 51a in the state where the control apparatus 200 is mounted on the fourth accessory 1D.

Therefore, since the control apparatus 200 is mounted on the fourth accessory 1D in the state where the to-be-mounted projecting portion 205 is inserted in the mounting recessed portion 51a, the engaging projecting portion 205b and the engaging recessed portion 205a are closed by the fourth accessory 1D, a hand does not accidentally come into contact with the engaging projecting portion 205b and the engaging recessed portion 205a in the state where the control apparatus 200 is mounted on the fourth accessory 1D, and thus, it is possible to prevent the control apparatus 200 from unintentionally falling off from the fourth accessory 1D.

Further, the engaging projecting portion 205b is engaged with the engaging groove 55a that is a recessed portion, the engaging recessed portion 205a is engaged with the locking portion 73 that is a projecting portion of the fourth accessory 1D, and thus, the control apparatus 200 is mounted on the fourth accessory 1D.

Therefore, since the control apparatus 200 can be mounted on the fourth accessory 1D only in a state where the engaging projecting portion 205b and the engaging recessed portion 205a are in a positional relationship corresponding to the engaging groove 55a and the locking portion 73, respectively, the control apparatus 200 is mounted always in a predetermined orientation on the fourth accessory 1D, and it is possible to prevent the control apparatus 200 from being mounted in a wrong orientation on the fourth accessory 1D.

In the state where the control apparatus 200 is mounted on the fourth accessory 1D, the support projections 56a, 56a of the left side wall portion 56 are brought into contact with the first contact portions 207a, 207a, and the support projections 57a, 57a of the right side wall portion 57 are brought into contact with the second contact portion 208a.

Therefore, the casing 201 is supported by the support projections 56a, 56a, 57a, and 57a in a state of being point-contacted at four points, rattling of the control apparatus 200 with respect to the apparatus mounting portion 91 is suppressed, and the control apparatus 200 is mounted in a stable state on the apparatus mounting portion 91.

Further, at this time, the projecting portion for terminal 205c of the to-be-mounted projecting portion 205 is inserted in the arrangement recessed portion 56b formed by the left side wall portion 56. Therefore, since any part of the apparatus mounting portion 91 does not come into contact with the connection terminals 209, 209, . . . , and it is possible to prevent the connection terminals 209, 209, . . . from being scratched or damaged.

As described above, in the fourth accessory 1D, the camera attachment portion 82 to/from which the imaging apparatus 150 attachable/detachable and the apparatus mounting portion 91 including the locking portion 73 to be engaged with the engaging recessed portion 205a that functions as an attachable/detachable portion (to-be-locked portion) are provided. The control apparatus 200 is locked to the apparatus mounting portion 91 by the locking portion 73.

Therefore, since the imaging apparatus 150 is attached to the camera attachment portion 82 and the control apparatus 200 is mounted on the apparatus mounting portion 91, it is possible to control the imaging apparatus 150 by the control apparatus 200 in the state where the imaging apparatus 150 is attached to the camera attachment portion 82, and improve the usability of the control apparatus 200.

Further, in the fourth accessory 1D, since the imaging apparatus 150 is attached to the camera attachment portion 82 and the control apparatus 200 is mounted on the apparatus mounting portion 91, it is possible to control the imaging apparatus 150 by the control apparatus 200 in the state where the imaging apparatus 150 is attached to the camera attachment portion 82, and improve the usability of the fourth accessory 1D.

Further, the mounting portion 80 including the apparatus mounting portion 91 is provided in the fourth accessory 1D, and the mounting portion 80 is attachable/detachable to/from the main body 79 including the camera attachment portion 82.

Therefore, the control apparatus 200 can be mounted on the mounting portion 80 including the apparatus mounting portion 91 in the state where the mounting portion 80 is detached from the part including the camera attachment portion 82, making it possible to improve the portability of the control apparatus 200.

Further, since it is possible to use only the mounting portion 80 of the fourth accessory 1D or the whole fourth accessory 1D, the range of the usage mode of the fourth accessory 1D is widened, and the usability of the fourth accessory 1D can be improved.

Note that since the fourth accessory 1D includes the main body 79 and the mounting portion 80, a different mounting portion may be mounted on the main body 79 for use instead of the mounting portion 80. Therefore, in the case where another type or shape of different control apparatus other than the control apparatus 200 can be mounted on an apparatus mounting portion of the different mounting portion, the different mounting portion on which the different control apparatus is mounted can be mounted on the main body 79 for use.

As described above, by making it possible to mount a different mounting portion on the main body 79, it is possible to improve the versatility.

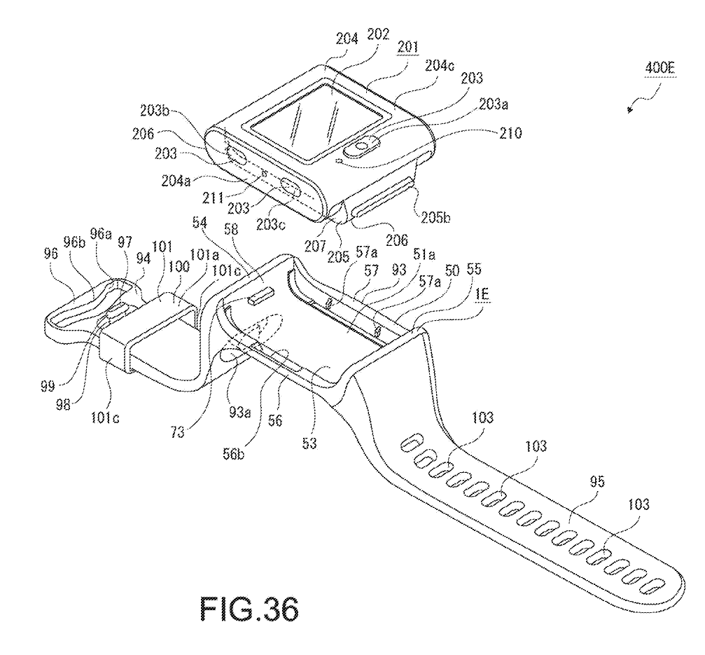

Next, a configuration, etc. of the fifth accessory 1E will be described (see FIG. 36 to FIG. 41).

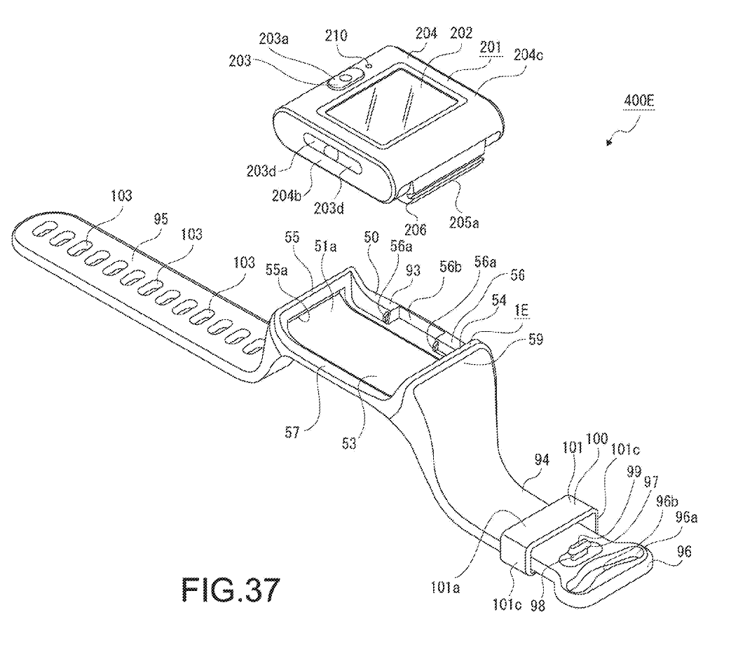

The fifth accessory 1E is formed by, for example, using a wristwatch as a motif, mounted on an arm for use, and includes an apparatus mounting portion 93 on which the control apparatus 200 is to be mounted, a first belt 94 continuous to the front end portion of the apparatus mounting portion 93, and a second belt 95 continuous to the rear end portion of the apparatus mounting portion 93 (see FIG. 36 and FIG. 37).

Since the apparatus mounting portion 93 has a shape and a structure similar to those of the above-mentioned third accessory 1C except for a part thereof, description of the apparatus mounting portion 93 will be omitted by applying reference symbols for the third accessory 1C to components similar to those of the third accessory 1C except for the part different from that of the third accessory 1C.

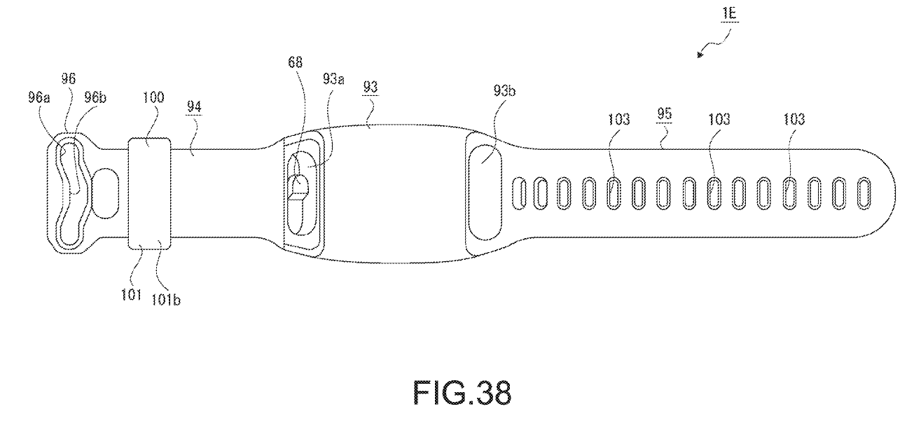

In the apparatus mounting portion 93, the insertion hole 93a communicated with space in which the locking mechanism 64 is placed is formed on the inner surface side that is to be mounted on an arm (see FIG. 38), and an insertion hole is not formed in the rear surface wall 58 unlike the third accessory 1C.

In the insertion hole 93a, the slide knob 67 of the locking mechanism 64 is placed. A user is capable of inserting the finger in the insertion hole 93a to operate the slide knob 67.

As described above, in the fifth accessory 1E, the slide knob 67 is provided on the surface side that comes into contact with the body in a state where the fifth accessory 1E is mounted on a part of the body.

Therefore, it is impossible to perform an operation on the slide knob 67 in the state where the fifth accessory 1E is mounted on the body (arm), and the locking mechanism 64 is not unintentionally operated, making it possible to prevent the control apparatus 200 from falling off from the fifth accessory 1E.

Further, since the slide knob 67 cannot be operated in the state where the fifth accessory 1E is mounted on the body, it is possible to suppress erroneous operations for the slide knob 67.

Note that the slide knob 67 may be provided on the surface opposite to the surface to be in contact with the body. In this case, it is possible to operate the slide knob 67 in the state where the fifth accessory 1E is mounted on the body, and it becomes easy to attach/detach the control apparatus 200 to/from the apparatus mounting portion 93.

A recessed portion 93b is formed on the inner surface of the rear end portion in the apparatus mounting portion 93. Since the recessed portion 93b is formed on the inner surface of the rear end portion in the apparatus mounting portion 93, the rear end portion of the apparatus mounting portion 93 is thinned, and the bendability of the second belt 95 continuous to the rear end portion of the apparatus mounting portion 93 with respect to the apparatus mounting portion 93 is improved.

The first belt 94 is formed of, for example, urethane except for a part thereof in order to secure a favorable bendability. Further, since the first belt 94 is formed of urethane or the like, it is elastically deformable.

The first belt 94 is continuous to the front wall portion 54 of the apparatus mounting portion 93 (see FIG. 36 to FIG. 38). The first belt 94 is provided as an insertion portion 96 that is formed to have a flat shape and has a tip portion formed to be wider than other parts. In the insertion portion 96, a belt insertion hole 96a is formed. The right and left end portions of the belt insertion hole 96a are located on the most tip side of the insertion portion 96, and the belt insertion hole 96a is gently displaced in the direction away from the tip as it goes from the right and left end portions to the center. Therefore, in the insertion portion 96, a projecting shape that projects on the side of the front wall portion 54 is formed, and this projecting shape is provided as a temporary fastening projecting portion 96b.

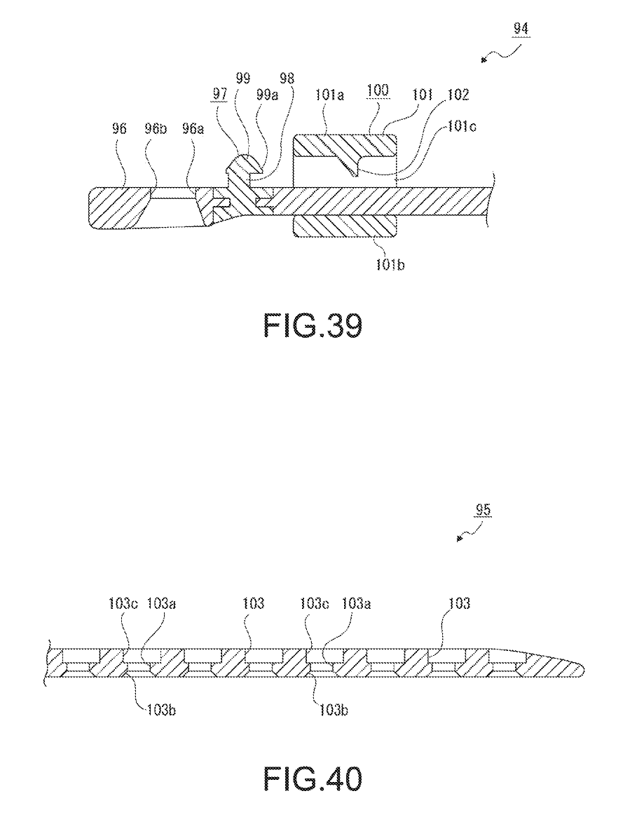

At a position near the tip of the first belt 94, a fastening projecting portion 97 is provided. The fastening projecting portion 97 includes a shaft portion 98, and a fastening portion 99 provided on the tip side of the shaft portion 98 (see FIG. 39). The fastening projecting portion 97 is a portion engaged with the second belt 95 when the fifth accessory 1E is mounted on the arm. The shaft portion 98 of the fastening projecting portion 97 may include a base portion that projects, and the fastening projecting portion 97 may be formed of a material different from those of other parts in the first belt 94. Examples of such a material include a material in which polycarbonate contains glass fiber or the like.

The fastening portion 99 is formed to have a curved surface shape whose tip surface projects upward, and the shaft portion 98 is continuous to a portion near the side of the insertion portion 96. Therefore, in the fastening portion 99, the projection amount of a part that projects on the side opposite to the insertion portion 96 with respect to the shaft portion 98 is larger than the projection amount of a part that projects on the side of the insertion portion 96 with respect to the shaft portion 98. In the fastening portion 99, the part that projects on the side opposite to the insertion portion 96 with respect to the shaft portion 98 is provided as a locking claw portion 99a.

In the first belt 94, a snap ring 100 is mounted on the side opposite to the insertion portion 96 with the fastening projecting portion 97 sandwiched therebetween. The snap ring 100 is formed of an elastically deformable material, and formed by integrally forming an annular portion 101 formed to have a rectangular tube shape, and a projecting portion for locking 102 that projects from the annular portion 101.

The annular portion 101 includes a first facing surface portion 101a from which the projecting portion for locking 102 projects, a second facing surface portion 101b that faces the first facing surface portion 101a, and a side portions 101c, 101c that couple the first facing surface portion 101a and the second facing surface portion 101b to each other. In the annular portion 101, the inner surface of the second facing surface portion 101b is mounted on the first belt 94. Therefore, space is formed between the first facing surface portion 101a and the first belt 94.

The projecting portion for locking 102 projects from the inner surface of the first facing surface portion 101a to the side of the second facing surface portion 101b.

The second belt 95 is formed of, for example, urethane in order to secure a favorable bendability. Further, since the second belt 95 is formed of urethane or the like, it is elastically deformable.

The second belt 95 is continuous to the rear end portion 55 of the apparatus mounting portion 93 (see FIG. 36 to FIG. 38). The second belt 95 is formed to have a flat shape, and the tip portion thereof is formed to have a substantially semicircular plate shape. In the second belt 95, fastening holes 103, 103, . . . are formed apart from each other at regular intervals in the longitudinal direction (see FIG. 40).

In each of the fastening holes 103, 103, . . . , a central part in the penetrating direction thereof is formed as a small diameter portion 103a, one end portion in the penetrating direction is formed as an enlarged diameter portion 103b whose diameter becomes larger as it goes away from the small diameter portions 103a, and a part on the side opposite to the enlarged diameter portion 103b with the small diameter portions 103a sandwiched therebetween is formed as a large diameter portion 103c having a diameter larger than that of the small diameter portions 103a.

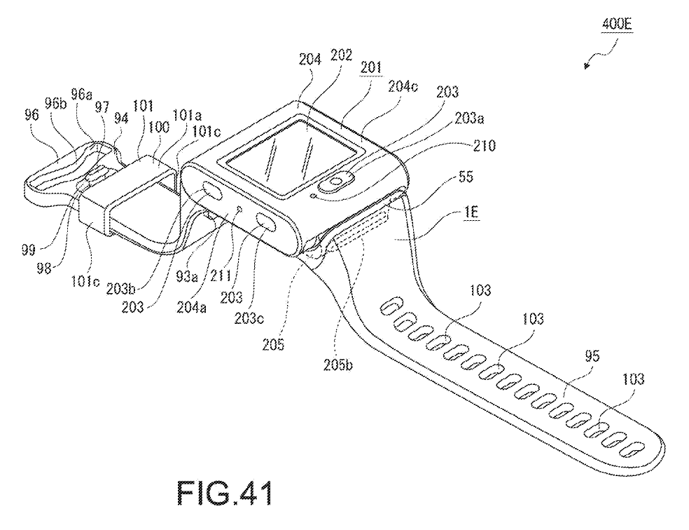

In the fifth accessory 1E configured as described above, by mounting the control apparatus 200 on the fifth accessory 1E while the imaging apparatus 150 is not attached to the fifth accessory 1E, the fifth accessory 1E and the control apparatus 200 constitute a control unit 400E (see FIG. 41).

In the state where the control apparatus 200 is mounted on the fifth accessory 1E, the to-be-mounted projecting portion 205 is inserted in the mounting recessed portion 51a formed in the fifth accessory 1E.

Therefore, since the control apparatus 200 is mounted on the apparatus mounting portion 93 in the state where the to-be-mounted projecting portion 205 is inserted in the mounting recessed portion 51a, it is possible to secure a stable mounted state with respect to the fifth accessory 1E. Also, since the main body portion 204 is not inserted in the mounting recessed portion 51a, it is possible to secure a favorable visibility with respect to the display control unit 202.

In particular, since the to-be-mounted projecting portion 205 is inserted in the mounting recessed portion 51a, the control apparatus 200 is hardly slid on the fifth accessory 1E, making it possible to prevent the control apparatus 200 from falling off from the fifth accessory 1E.

Further, since the to-be-mounted projecting portion 205 is inserted in the mounting recessed portion 51a, it is possible to reduce the overall size of the fifth accessory 1E.

Further, the engaging projecting portion 205b and the engaging recessed portion 205a are formed in the to-be-mounted projecting portion 205, and the to-be-mounted projecting portion 205 is inserted in the mounting recessed portion 51a in the state where the control apparatus 200 is mounted on the fifth accessory 1E.

Therefore, since the control apparatus 200 is mounted on the fifth accessory 1E in the state where the to-be-mounted projecting portion 205 is inserted in the mounting recessed portion 51a, the engaging projecting portion 205b and the engaging recessed portion 205a are closed by the fifth accessory 1E, a hand does not accidentally come into contact with the engaging projecting portion 205b and the engaging recessed portion 205a in the state where the control apparatus 200 is mounted on the fifth accessory 1E, and thus, it is possible to prevent the control apparatus 200 from unintentionally falling off from the fifth accessory 1E.

Further, the engaging projecting portion 205b is engaged with the engaging groove 55a that is a recessed portion, the engaging recessed portion 205a is engaged with the locking portion 73 that is a projecting portion of the fifth accessory 1E, and thus, the control apparatus 200 is mounted on the fifth accessory 1E.

Therefore, since the control apparatus 200 can be mounted on the fifth accessory 1E only in a state where the engaging projecting portion 205b and the engaging recessed portion 205a are in a positional relationship corresponding to the engaging groove 55a and the locking portion 73, respectively, the control apparatus 200 is mounted always in a predetermined orientation on the fifth accessory 1E, and it is possible to prevent the control apparatus 200 from being mounted in a wrong orientation on the fifth accessory 1E.

In the state where the control apparatus 200 is mounted on the fifth accessory 1E, the support projections 56a, 56a of the left side wall portion 56 are brought into contact with the first contact portions 207a, 207a, and the support projections 57a, 57a of the right side wall portion 57 are brought into contact with the second contact portion 208a.

Therefore, the casing 201 is supported by the support projections 56a, 56a, 57a, and 57a in a state of being point-contacted at four points, rattling of the control apparatus 200 with respect to the apparatus mounting portion 93 is suppressed, and the control apparatus 200 is mounted in a stable state on the apparatus mounting portion 93.

Further, at this time, the projecting portion for terminal 205c of the to-be-mounted projecting portion 205 is inserted in the arrangement recessed portion 56b formed by the left side wall portion 56. Therefore, since any part of the apparatus mounting portion 93 does not come into contact with the connection terminals 209, 209, . . . , and it is possible to prevent the connection terminals 209, 209, . . . from being scratched or damaged.

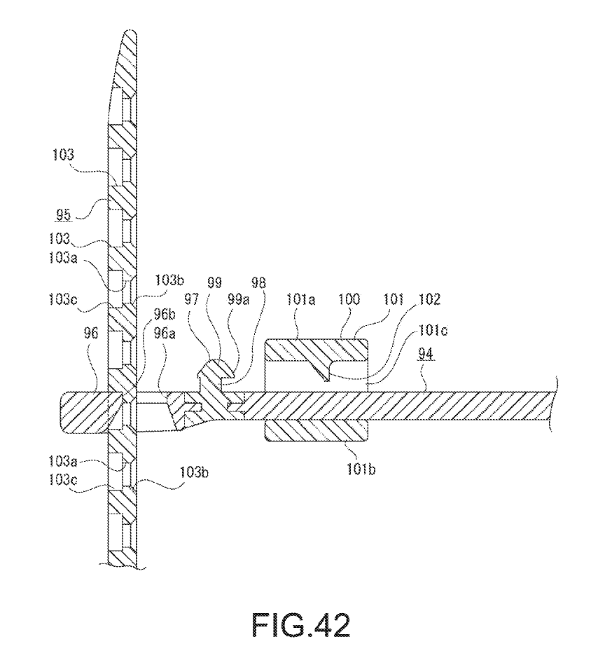

The fifth accessory 1E is mounted on the arm as follows (see FIG. 42 to FIG. 44).

First, the inner surface of the apparatus mounting portion 93 is placed on the arm, the first belt 94 and the second belt 95 are each bent in a substantially circular arc shape, and the second belt 95 is inserted through the belt insertion hole 96a of the first belt 94 (see FIG. 42). At this time, the temporary fastening projecting portion 96b of the first belt 94 is engaged with the opening edge of the fastening hole 103 formed in the second belt 95, and the second belt 95 is temporarily fastened by the first belt 94, thereby preventing the second belt 95 from coming out of the belt insertion hole 96a.

Since the temporary fastening projecting portion 96b is provided in the fifth accessory 1E as described above, it is possible to temporarily fastening the second belt 95 to the first belt 94 in the middle of mounting to the arm, thereby improving the workability of the mounting operation.

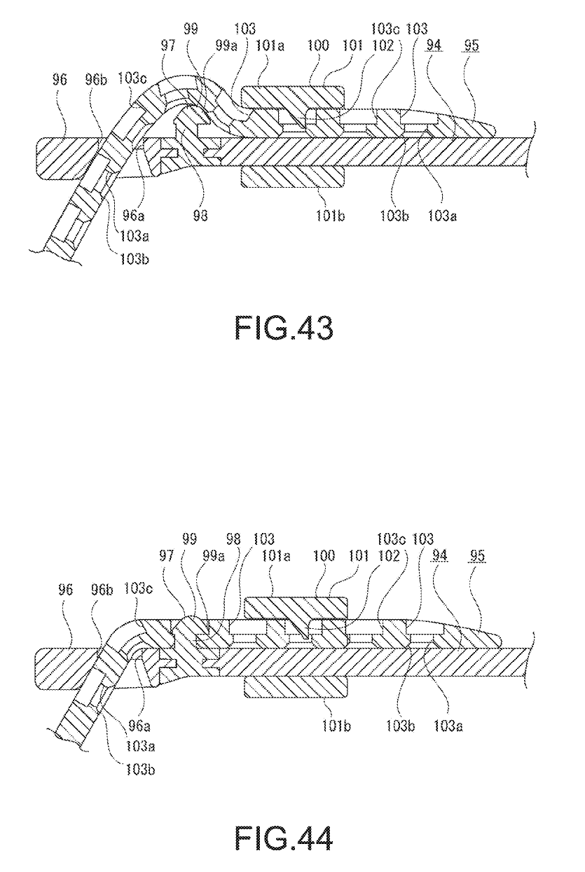

Next, the second belt 95 is inserted in the snap ring 100 (see FIG. 43). At this time, the second belt 95 is slid on the fastening portion 99 of the fastening projecting portion 97. However, since the tip surface of the fastening portion 99 is formed to have a curved surface shape, the second belt 95 is smoothly slid on the fastening portion 99. Therefore, it is possible to smoothly and easily insert the second belt 95 in the snap ring 100. In the state where the second belt 95 is inserted in the snap ring 100, the projecting portion for locking 102 is inserted in the fastening hole 103.

Next, the fastening projecting portion 97 is inserted in the fastening hole 103 different from the fastening hole 103 in which the projecting portion for locking 102 is inserted (see FIG. 44). At this time, since the enlarged diameter portion 103b whose diameter becomes larger as it goes away from the small diameter portions 103a is formed in the fastening hole 103, the fastening portion 99 is guided by the enlarged diameter portion 103b, and the fastening projecting portion 97 is smoothly inserted in the fastening hole 103. Further, since the tip surface of the fastening portion 99 of the fastening projecting portion 97 is formed to have a curved surface shape, the fastening projecting portion 97 is more smoothly inserted in the fastening hole 103.

The fastening projecting portion 97 is inserted in the fastening hole 103 while spreading the small diameter portions 103a, and the fastening portion 99 is located in the large diameter portion 103c.

When the hand is released from the first belt 94 and the second belt 95 that have been held by the hand in the state where the projecting portion for locking 102 and the fastening projecting portion 97 are inserted in the fastening hole 103, 103 as described above, the first belt 94 and the second belt 95 that are each bent in a substantially circular arc shape tries to return to the original state. Therefore, the projecting portion for locking 102 is engaged with the peripheral surface that forms the fastening hole 103, and the locking claw portion 99a of the fastening portion 99 is engaged with the surface that forms the large diameter portion 103c.

The projecting portion for locking 102 and the fastening portion 99 are engaged with the respective portions as described above, and thus, the fifth accessory 1E is mounted on the arm. Since the locking claw portion 99a having a large projection amount from the shaft portion 98 is provided in the fastening portion 99, the locking area of the locking claw portion 99a to the second belt 95 is large, the locking state of the fastening portion 99 to the second belt 95 is hardly released, and the second belt 95 is coupled to the first belt 94 in a stable state.

### CONCLUSION

As described above, the control apparatus 200 includes a communication unit capable of wirelessly communicating with the imaging apparatus 150, the display control unit 202 that displays information regarding the imaging apparatus 150 on the basis of communication with the imaging apparatus 150, and the engaging recessed portion 205a that is engageable with the locking portion 23a, 40a, or 73 of the accessory 1A, 1B, 1C, 1D, or 1E and attachable/detachable to/from the accessory 1A, 1B, 1C, 1D, or 1E.

Therefore, since the control apparatus 200 is capable of wirelessly connecting to the imaging apparatus 150 in the state of being locked to the accessory 1A, 1B, 1C, 1D, or 1E and control can be performed on the imaging apparatus 150, it is possible to improve the convenience of handling the control apparatus 200.

<Others>

An example in which the engaging recessed portion 205a and the engaging projecting portion 205b are formed in the control apparatus 200, and the engaging recessed portion 205a and the engaging projecting portion 205b are respectively engaged with the projecting portion and the recessed portion of the accessory 1A, 1B, 1C, 1D, or 1E and locked has been described above.

However, two engaging recessed portions may be formed in the control apparatus 200, two projecting portions may be provided in the accessory 1A, 1B, 1C, 1D, or 1E, the two projecting portions may be engaged with the two engaging recessed portions, and thus, the control apparatus 200 may be locked. Alternatively, two engaging projecting portions may be provided in the control apparatus 200, two recessed portions may be provided in the accessory 1A, 1B, 1C, 1D, or 1E, the two recessed portions may be engaged with the two engaging projecting portions, and thus, the control apparatus 200 may be locked.

Further, a configuration in which the control apparatus 200 is locked to the accessory 1A, 1B, 1C, 1D, or 1E has been described above. On the contrary, the accessory 1A, 1B, 1C, 1D, or 1E may be locked to the control apparatus 200.

<Present Technology>

It should be noted that the present technology may take the following configurations.

(1)

A control apparatus, including:

a communication unit capable of wirelessly communicating with an imaging apparatus;

a display control unit that displays information regarding the imaging apparatus on the basis of communication with the imaging apparatus; and

an attachable/detachable portion that is engageable with a locking portion of an accessory and attachable/detachable to/from the locking portion of the accessory.

(2)

The control apparatus according to (1) above, in which

an engaging projecting portion and an engaging recessed portion are formed,

one of the engaging projecting portion and the engaging recessed portion is formed as the attachable/detachable portion, and

the other of the engaging projecting portion and the engaging recessed portion is engaged with a recessed portion or a projecting portion formed in the accessory.

(3)

The control apparatus according to (1) or (2) above, in which

a casing is provided, the display control unit being placed in the casing,

a main body portion and a to-be-mounted projecting portion are provided in the casing, the display control unit being placed in the main body portion, the to-be-mounted projecting portion projecting from the main body portion, the to-be-mounted projecting portion including the attachable/detachable portion, and

the to-be-mounted projecting portion is inserted in a mounting recessed portion in a state of being attached to the accessory, the mounting recessed portion being formed in the accessory.

(4)

The control apparatus according to (2) above, in which

a casing is provided, the display control unit being placed in the casing,

a main body portion and a to-be-mounted projecting portion are provided in the casing, the display control unit being placed in the main body portion, the to-be-mounted projecting portion projecting from the main body portion,

the engaging projecting portion and the engaging recessed portion are formed in the to-be-mounted projecting portion, and the to-be-mounted projecting portion is inserted in a mounting recessed portion in a state of being attached to the accessory, the mounting recessed portion being formed in the accessory.

(5)

The control apparatus according to (3) or (4) above, in which

a to-be-guided inclined surface slidable on an opening edge of the mounting recessed portion is formed in the to-be-mounted projecting portion.

(6)

The control apparatus according to any one of (1) to (5) above, in which

a plurality of contact portions that are point-contacted with corresponding parts of the accessory in a state of being attached to the accessory are provided.

(7)

The control apparatus according to any one of (2) to (6) above, in which

a casing is provided, the display control unit being placed in the casing,

a plurality of operation buttons including an imaging button for causing the imaging apparatus to execute an imaging operation are placed in the casing, and

the display control unit and the imaging button are placed on the same surface of the casing.

(8)

The control apparatus according to (7) above, in which

the imaging button and another operation button are placed on different surfaces of the casing.

(9)

The control apparatus according to (7) or (8) above, in which

the operation buttons are placed on opposite surfaces of the casing,

the opposite surfaces are formed to have the same size and the same shape, and

a position on one of the opposite surfaces of the operation button placed on the one of the opposite surfaces is different from a position on the other of the opposite surfaces of the operation button placed on the other of the opposite surfaces.

(10)

The control apparatus according to any one of (7) to (9) above, in which

at least one of surfaces of the casing is formed to have a recessed surface, and

at least one of the operation buttons is placed on the recessed surface.

(11)

The control apparatus according to any one of (1) to (10) above, in which

a connection terminal to be connected to a terminal portion of the accessory is provided,

the connection terminal is slidable with respect to the accessory, and

the connection terminal is slidable on the connection terminal in a sliding state with respect to the accessory.

(12)

The control apparatus according to any one of (1) to (11) above, in which

a camera attachment portion and an apparatus mounting portion are provided in the accessory, the imaging apparatus being attachable/detachable to/from the camera attachment portion, the apparatus mounting portion including a locking portion to be engaged with the attachable/detachable portion, and

the control apparatus is locked to the apparatus mounting portion by the locking portion.

(13)

The control apparatus according to (12) above, in which

a mounting portion including the apparatus mounting portion is provided in the accessory, and

the mounting portion is attachable/detachable to/from a part including the camera attachment portion.

(14)

The control apparatus according to (12) above, in which

a grip portion to be held by a finger is provided in the accessory.

(15)

The control apparatus according to (14) above, in which

the apparatus mounting portion is rotatable with respect to the camera attachment portion, and

an orientation with respect to the imaging apparatus is changed in accordance with rotation of the apparatus mounting portion.

(16)

The control apparatus according to any one of (1) to (11) above, in which

a weep hole is formed in the accessory.

(17)

The control apparatus according to any one of (1) to (11) above, in which

the accessory is attachable to a part of a human body, and

a knob for causing a lock lever including the locking portion to operate is provided on a side of a surface in contact with the body in a state of being attached to the part of the body.

(18)

The control apparatus according to any one of (1) to (11) above, in which

an elastically deformable elastic deformation portion is provided in the accessory, and

the locking portion is provided in the elastic deformation portion.

(19)

A control unit, including:

an accessory including a locking portion; and

a control apparatus including a communication unit capable of wirelessly communicating with an imaging apparatus, a display control unit that displays information regarding the imaging apparatus on the basis of communication with the imaging apparatus, and an attachable/detachable portion that is engageable with a locking portion of an accessory and attachable/detachable to/from the locking portion of the accessory.

(20)

An imaging unit, including:

an imaging apparatus having an imaging function;

an accessory including a locking portion; and

a control apparatus including a communication unit capable of wirelessly communicating with an imaging apparatus, a display control unit that displays information regarding the imaging apparatus on the basis of communication with the imaging apparatus, and an attachable/detachable portion that is engageable with a locking portion of an accessory and attachable/detachable to/from the locking portion of the accessory.

### REFERENCE SIGNS LIST

1A first accessory
15 apparatus mounting portion
15a mounting recessed portion
18 elastic deformation portion
19a engaging groove (recessed portion)
23a locking portion (projecting portion)
34 camera attachment portion
35 grip portion
150 imaging apparatus
200 control apparatus
201 casing
202 display control unit
203 operation button
203a imaging button
204 main body portion
204a first recessed surface
204b second recessed surface
205 to-be-mounted projecting portion
205a engaging recessed portion (attachable/detachable portion)
205b engaging projecting portion
207 to-be-guided inclined surface
207a first contact portion
208 to-be-guided inclined surface
208a first contact portion
209 connection terminal
300A imaging unit
400A control unit
1B second accessory
37a mounting recessed portion
40a locking portion (projecting portion)
41a engaging groove (recessed portion)
45 elastic deformation portion
400B control unit
1C third accessory
51a mounting recessed portion
53a weep hole
55a engaging groove (recessed portion)
67 slide knob
73 locking portion (projecting portion)
400C control unit
1D fourth accessory
80 attachment portion
82 camera attachment portion
91 apparatus mounting portion
300D imaging unit
400D control unit
1E fifth accessory
93 apparatus mounting portion
400E control unit

1. A control apparatus, comprising:
a communication unit capable of wirelessly communicating with an imaging apparatus;
a display control unit that displays information regarding the imaging apparatus on the basis of communication with the imaging apparatus; and
an attachable/detachable portion that is engageable with a locking portion of an accessory and attachable/detachable to/from the locking portion of the accessory.

2. The control apparatus according to claim 1, wherein
an engaging projecting portion and an engaging recessed portion are formed,
one of the engaging projecting portion and the engaging recessed portion is formed as the attachable/detachable portion, and
the other of the engaging projecting portion and the engaging recessed portion is engaged with a recessed portion or a projecting portion formed in the accessory.

3. The control apparatus according to claim 1, wherein
a casing is provided, the display control unit being placed in the casing,
a main body portion and a to-be-mounted projecting portion are provided in the casing, the display control unit being placed in the main body portion, the to-be-mounted projecting portion projecting from the main body portion, the to-be-mounted projecting portion including the attachable/detachable portion, and
the to-be-mounted projecting portion is inserted in a mounting recessed portion in a state of being attached to the accessory, the mounting recessed portion being formed in the accessory.

4. The control apparatus according to claim 2, wherein
a casing is provided, the display control unit being placed in the casing,
a main body portion and a to-be-mounted projecting portion are provided in the casing, the display control unit being placed in the main body portion, the to-be-mounted projecting portion projecting from the main body portion,
the engaging projecting portion and the engaging recessed portion are formed in the to-be-mounted projecting portion, and
the to-be-mounted projecting portion is inserted in a mounting recessed portion in a state of being attached to the accessory, the mounting recessed portion being formed in the accessory.

5. The control apparatus according to claim 3, wherein
a to-be-guided inclined surface slidable on an opening edge of the mounting recessed portion is formed in the to-be-mounted projecting portion.

6. The control apparatus according to claim 1, wherein
a plurality of contact portions that are point-contacted with corresponding parts of the accessory in a state of being attached to the accessory are provided.

7. The control apparatus according to claim 2, wherein
a casing is provided, the display control unit being placed in the casing,
a plurality of operation buttons including an imaging button for causing the imaging apparatus to execute an imaging operation are placed in the casing, and
the display control unit and the imaging button are placed on the same surface of the casing.

8. The control apparatus according to claim 7, wherein
the imaging button and another operation button are placed on different surfaces of the casing.

9. The control apparatus according to claim 7, wherein
the operation buttons are placed on opposite surfaces of the casing,
the opposite surfaces are formed to have the same size and the same shape, and
a position on one of the opposite surfaces of the operation button placed on the one of the opposite surfaces is different from a position on the other of the opposite surfaces of the operation button placed on the other of the opposite surfaces.

10. The control apparatus according to claim 7, wherein
at least one of surfaces of the casing is formed to have a recessed surface, and
at least one of the operation buttons is placed on the recessed surface.

11. The control apparatus according to claim 11, wherein
a connection terminal to be connected to a terminal portion of the accessory is provided,
the connection terminal is slidable with respect to the accessory, and
the connection terminal is slidable on the connection terminal in a sliding state with respect to the accessory.

12. The control apparatus according to claim 1, wherein
a camera attachment portion and an apparatus mounting portion are provided in the accessory, the imaging apparatus being attachable/detachable to/from the camera attachment portion, the apparatus mounting portion including a locking portion to be engaged with the attachable/detachable portion, and
the control apparatus is locked to the apparatus mounting portion by the locking portion.

13. The control apparatus according to claim 12, wherein
a mounting portion including the apparatus mounting portion is provided in the accessory, and
the mounting portion is attachable/detachable to/from a part including the camera attachment portion.

14. The control apparatus according to claim 12, wherein
a grip portion to be held by a finger is provided in the accessory.

15. The control apparatus according to claim 14, wherein
the apparatus mounting portion is rotatable with respect to the camera attachment portion, and
an orientation with respect to the imaging apparatus is changed in accordance with rotation of the apparatus mounting portion.

16. The control apparatus according to claim 1, wherein
a weep hole is formed in the accessory.

17. The control apparatus according to claim 1, wherein
the accessory is attachable to a part of a human body, and
a knob for causing a lock lever including the locking portion to operate is provided on a side of a surface in contact with the body in a state of being attached to the part of the body.

18. The control apparatus according to claim 1, wherein
an elastically deformable elastic deformation portion is provided in the accessory, and
the locking portion is provided in the elastic deformation portion.

19. A control unit, comprising:
an accessory including a locking portion; and
a control apparatus including a communication unit capable of wirelessly communicating with an imaging apparatus, a display control unit that displays information regarding the imaging apparatus on the basis of communication with the imaging apparatus, and an attachable/detachable portion that is engageable with a locking portion of an accessory and attachable/detachable to/from the locking portion of the accessory.

20. An imaging unit, comprising:
an imaging apparatus having an imaging function;
an accessory including a locking portion; and
a control apparatus including a communication unit capable of wirelessly communicating with an imaging apparatus, a display control unit that displays information regarding the imaging apparatus on the basis of communication with the imaging apparatus, and an attachable/detachable portion that is engageable with a locking portion of an accessory and attachable/detachable to/from the locking portion of the accessory.
